(19) United States
(12) Patent Application Publication
(10) Pub. No.: US 2015/0163189 A1
(43) Pub. Date: Jun. 11, 2015

(54) SOCIAL MESSAGING SYSTEM AND METHOD

(71) Applicant: Sweigh, Inc., Centerport, NY (US)

(72) Inventors: James N. Proctor, Huntington, NY (US); Christian B. Monteleone, Centerport, NY (US)

(21) Appl. No.: 14/565,225

(22) Filed: Dec. 9, 2014

Related U.S. Application Data
(60) Provisional application No. 61/914,043, filed on Dec. 10, 2013.

(51) Int. Cl. H04L 12/58; G06F 3/0488; G06F 3/0484; G06F 3/0481; G06F 3/0482

(52) U.S. Cl. CPC H04L 51/32; G06F 3/04817; G06F 3/0482; G06F 3/04842; G06F 3/0488

(57) ABSTRACT

Embodiments of the invention provide a system for facilitating user engagement with a high profile person or brand including program logic defining a content message service that facilitates engagement of a user with a high profile person. When executed by a processor the program logic performs steps to enable user account formation, content category selection and viewing, creation and posting of a content message, calculating a content message ranking and a decay for each posted content message, displaying a content message, and enabling a user to create a votable answer. The steps include compiling a total number of content messages composed by the user, the total number of responses to the messages, the high profile person viewing or response total from the high profile person's viewing or response behavior to the content message and assigning a status category, score, and status value to the user.

### RELATED APPLICATIONS

This application claims priority from Provisional Application No. 61/914,043, entitled SOCIAL MESSAGING SYSTEM AND METHOD, filed on Dec. 10, 2013, the entire contents of which are incorporated herein by reference.

### BACKGROUND

Mobile messaging and online social networking platforms can allow users to create and distribute communications viewable by all other users of the platforms. Typically, user communications can comprise information including questions or comments relating to news events, products and brands, or can be communications associated with one or more high profile individuals, such as entertainers, musicians, athletes, or other celebrities. Even though mobile messaging and social networking platforms have now established a global reach, invariably penetrating almost every aspect of our lives, the ability for any single individual user to gain visibility, increase prominence, and/or migrate to a level of one-on-one communication with any one high profile individual user or brand is limited. More often than not, if a user is able to establish connection with a high profile person, or organization, or brand, it can occur due to chance alone. In turn, the ability of any one high profile person, or organization, or brand to strategically select and establish direct communication with any one or more users is limited, reducing opportunities for the high profile person, or organization, or brand to monetize a fan base.

### SUMMARY

Some embodiments of the invention include a system for facilitating user engagement with a high profile person or brand comprising at least one processor configured to couple to at least one server, and at least one non-transitory computer-readable storage medium for tangibly storing information related to at least one user account. The non-transitory computer-readable storage medium includes program logic defining a content message service that facilitates engagement of a user with at least one high profile person. When executed by the processor the program logic performs steps comprising providing an option to a user to create a user account and provide user profile information to the content message service, and calculating and rendering at least one user interface on a computer device of viewing user that is coupled to the content message service. The steps further comprise providing an option to the user to select and view at least one content category, and providing an option to a user to create and post at least one content message. The steps further comprise calculating a content message ranking and a decay for each posted content message, and displaying the at least one content message within the least one user interface based at least in part on the decay. The steps further comprise providing an option to a user to create at least one votable answer associated with the at least one content message, and providing an option to a viewing user to place a vote by selecting the at least one votable answer. The steps further comprise compiling a total number of content messages composed by the user, and compiling a total number of responses to the content messages composed by the user. Further, the steps comprise compiling a high profile person viewing or response total from the at least one high profile person's viewing or response behavior to the at least one content message. The steps also comprise calculating and assigning a status category, a score, and a status value to the user based at least in part on at least one of the total number of content messages composed by the user, total number of responses to the content messages composed by the user, and a high profile person viewing or response total. Further, the steps comprise displaying the status category of a user associated with the at least one high profile person when requested by the user.

In some embodiments, the decay is a function of a level of decay calculated by the content message service using the processor. In some further embodiments, the level of decay is defined by the content messaging service based on the number of newly created content messages. In some embodiments, the level of decay is defined by the content messaging service based on a content message's age relative to its finite life. In some embodiments, the level of decay is defined by the content messaging service based on the content message's rank.

In some embodiments, the user comprises a high profile person. In some other embodiments, the high profile person comprises a brand or organization. In some further embodiments, the high profile person comprises at least one of an athlete, an artist, an entertainer, an actor, a musician, a dancer, a comedian, and a celebrity.

In some embodiments, the option to place a vote comprises the content message service recognizing and accepting a user selection of a voting button or icon. In other embodiments, the voting button or icon is configured to be activated by the user by swiping. In some further embodiments, the voting button or icon is configured to be activated at least one user gesture.

In some embodiments, assignment of a status category to the user is dependent on the purchase of content message influence via an in-application purchase by the user.

Some embodiments of the invention include the processor executing the program logic to configure the user interface display to enable a user to complete or cancel a purchase of content message influence related to the at least one high profile person. In some embodiments, the user profile information is provided through at least one third-party social media system.

Some embodiments of the invention include the processor executing the program logic to configure the user interface display with a find a friend or follower function. Some further embodiments include the processor executing the program logic to enable a user to invite one or more friends to the content messaging service. Some other embodiments include the processor executing the program logic to display trending information and at least one trending content message.

In some embodiments, the processor executes the program logic to display at least one advertisement on the at least one user interface. In some embodiments, the at least one advertisement comprises at least one of feed brand content messages ads with call to action, special offers, and alerts for discounts from advertising or brand partners.

In some embodiments of the invention, the prominence of display of the at least one content message is based at least in part on the content message ranking. In some embodiments, the content message ranking is a function of the status category of the user.

In some embodiments, the content message ranking is defined by an equation comprising number of responses (“R”)×author's status (“S”)×decay (“D”). In some further embodiments, the level of decay depends on a decay bonus earned, where the decay bonus is based on the status category of the user. In some further embodiments, the status category of a user is further defined by (# of content messages created×X %)+(# of user responses×Y %)+(# HPP responses×Z) where the variables X % and Y % are weighting factors that ranges between about 0 and about 100%, and Z is a weighting factor that ranges between about 0 and about 100.

In some embodiments, the content message service is configured to couple to one or more 3rd party content providers websites, mobile sites, and other content portals that can display at least one content message using HTML code. In some embodiments, the HTML code comprises an iframe.

### DESCRIPTION OF THE DRAWINGS

FIG. 1A illustrates an example of a home screen generated by a content messaging service system according to one embodiment of the invention.

FIG. 1B illustrates an example of a home screen generated by a content messaging service system according to one embodiment of the invention.

FIG. 1C illustrates an example of a home screen generated by a content messaging service system according to one embodiment of the invention.

FIG. 2A illustrates an example of a “view content message” screen generated by a content messaging service system according to one embodiment of the invention.

FIG. 2B illustrates an example of a “view content” screen generated by a content messaging service system according to one embodiment of the invention.

FIG. 2C illustrates an example of a “view content message” screen generated by a content messaging service system according to one embodiment of the invention.

FIG. 3A illustrates an example of a “create” screen generated by a content messaging service system according to one embodiment of the invention.

FIG. 3B illustrates an example of a “create” screen generated by a content messaging service system according to one embodiment of the invention.

FIG. 3C illustrates an example of a “create” screen generated by a content messaging service system according to one embodiment of the invention.

FIG. 4A illustrates an example of a “me” screen generated by a content messaging service system according to one embodiment of the invention.

FIG. 4B illustrates an example of a “profile” screen generated by a content messaging service system according to one embodiment of the invention.

FIG. 4C illustrates an example of a “settings” screen generated by a content messaging service system according to one embodiment of the invention.

FIG. 5A illustrates an example of a “browse” screen generated by a content messaging service system according to one embodiment of the invention.

FIG. 5B illustrates an example of a “browse” screen generated by a content messaging service system according to one embodiment of the invention.

FIG. 6A illustrates an example of an “advertising” screen generated by a content messaging service system according to one embodiment of the invention.

FIG. 6B illustrates an example of an “advertising” screen generated by a content messaging service system according to one embodiment of the invention.

FIG. 6C illustrates an example of an “advertising” screen generated by a content messaging service system according to one embodiment of the invention.

FIG. 7A illustrates an example of a “view trending content messages” screen generated by a content messaging service system according to one embodiment of the invention.

FIG. 7B illustrates an example of a screen generated by a content messaging service system including message organization options according to one embodiment of the invention.

FIG. 7C illustrates an example of a screen generated by a content messaging service system including information for keeping track of a user's status within multiple HPP communities according to one embodiment of the invention.

FIG. 7D illustrates an example of a screen generated by a content messaging service system for creating direct messages in the form of ideas and questions with uniform answers according to one embodiment of the invention.

FIG. 8A depicts one example definition of a content message according to one embodiment of the invention.

FIG. 8B shows a content message status diagram according to one embodiment of the invention.

FIG. 9A shows one example of a content message status calculation according to one embodiment of the invention.

FIG. 9B shows one example of a user's status calculation according to one embodiment of the invention.

FIG. 9C shows a table detailing the decay bonus earned based on the author's status according to one embodiment of the invention.

FIG. 9D shows a table detailing content message ranking calculations according to one embodiment of the invention.

FIG. 10 shows one example of a system architecture implementation useful for performing one or more of the methods of the content messaging service system according to at least one embodiment of the invention.

FIG. 11 illustrates a trending topics and search display in accordance with some embodiments of the invention.

FIG. 12 illustrates a featured sub-categories display in accordance with some embodiments of the invention.

FIG. 13 illustrates a saved messages display of the content messaging service system in accordance with some embodiments of the invention.

FIG. 14 illustrates a notifications display in accordance with some embodiments of the invention.

FIG. 15 illustrates a private messages display of the content messaging service system in accordance with some embodiments of the invention.

FIG. 16 illustrates a user profile display of the content messaging service system in accordance with some embodiments of the invention.

FIG. 17 illustrates a creating and editing a channel of the content messaging service system in accordance with some embodiments of the invention.

FIG. 18 illustrates a creating and editing channels of the content messaging service system in accordance with some embodiments of the invention.

FIG. 19 illustrates finding and editing messages of the content messaging service system in accordance with some embodiments of the invention.

FIG. 20 illustrates selecting and trending channels content messaging service system in accordance with some embodiments of the invention.

FIG. 21 illustrates selecting featured channels of the content messaging service system in accordance with some embodiments of the invention.

FIG. 22 illustrates finding and editing users of the content messaging service system in accordance with some embodiments of the invention.

FIG. 23 illustrates an upload tool for importing messages of the content messaging service system in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include a computer implemented content messaging service system for creating at least one displayable message to allow at least one user (e.g., a fan) to communicate and/or connect with at least one high profile person, or organization, or brand (hereinafter referred to as “HPP”). For the purposes of this disclosure, an HPP as used throughout can be defined as referring to least one high profile person, or at least one organization, or at least one brand, or a combination thereof. For example, in some embodiments, the HPP can include a high profile person representing at least one consumer brand. In some other embodiments, the HPP comprises a brand that may not necessarily be associated with any one high profile person. In some embodiments, the HPP can include for example athletes, artists, entertainers, actors and actresses, musicians, dancers, comedians, and other celebrities.

In some embodiments, a user, such as a fan, can use the computer implemented content messaging service system to create and display at least one message intended by a user to at least partially influence an HPP. In this instance, the created and displayed message can be termed a content message, created by and/or with assistance from the computer implemented content messaging service system. For example, in some embodiments, a fan can use the computer implemented content messaging service system to create a content message that can allow the fan to influence an HPP. Further, in some other embodiments, an HPP can use the computer implemented content messaging service system to create a content message that can allow the HPP to influence at least one user (e.g. at least one fan). In some embodiments, a user can earn status to move closer to the HPPs inner circle. In some embodiments, the content messaging service system can facilitate a user having one-to-one communication with one or more HPP's.

Some embodiments of the invention can provide the capability of enabling a user (e.g. a fan) to compose, view and vote on at least one content message. Moreover, in some further embodiments of the invention, the computer implemented content messaging service system can enable an HPP to compose, view and vote on at least one content message. For example, in some embodiments, the computer implemented content messaging service system can enable an HPP to compose, view and vote on at least one content message. In other embodiments, one or more representatives owning and/or controlling a brand can use the computer implemented content messaging service system to compose, view and vote on at least one content message. In some embodiments, a content message can aid in organization and simplification of communication in a way that ensures only the most interesting and popular messages are readily viewable and actionable. Moreover, in some embodiments, the computer implemented content messaging service system can reduce message clutter and can focus results for all parties involved.

In some embodiments, a plurality of users can join forces to elevate a content message to an HPP. In some embodiments, this is done by “tapping” other fans in an HPP community who have created similar content messages. In some embodiments, by combining their content messages, users can be enabled by the content messaging service system to increase their probability of being noticed as their status and trending can be exponentially stronger depending on how many users team up using the content messaging service system. In some embodiments, answer and interaction options can be introduced so that the content messages that garner the highest number of responses can be viewed by the HPP upon logging-in to the content messaging service system.

Some embodiments of the invention can provide the capability of enabling an HPP to engage their fan base using one or more conventional social platforms, and to point them to a content message to answer questions, and weigh in on ideas to get concise feedback. In some embodiments, the HPP can receive direct share of revenue when they sign up new users and collect valuable data which can be marketed. For example, some embodiments of the content messaging service system can identify the most engaged fans around an HPP for direct marketing and sales follow-up. In this instance, the content messaging service system can filter the casual follower versus someone who wants to be engaged. Moreover, in some embodiments, the content messaging service system can enable a frequent or continual dialog with the fan base and the HPP with substantially real-time response.

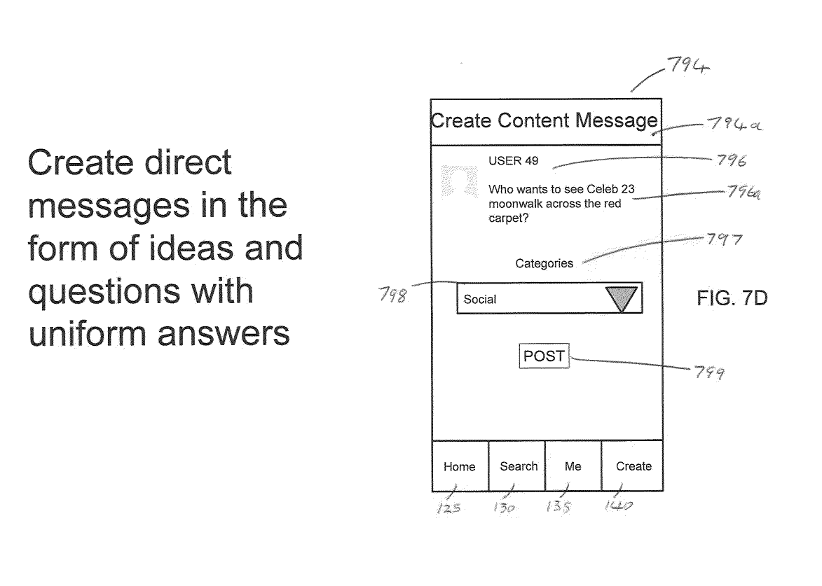

Some embodiments of the invention can include a user registration process. For example, in some embodiments, a user who wishes to use the content messaging service system can execute a free download of a content message application (i.e., at least one software module capable of communicating with the computer implemented content messaging service system) from an application store associated with their messaging device. For example, in some embodiments, one or more components of a network (e.g. network 39a, 39b in FIG. 10) can be configured to execute at least one content message application, and can include a number of client devices including, but not limited to, desktop computers, laptop computers, digital assistants, personal digital assistants, cellular phones, mobile phones, smart phones, pagers, digital tablets, internet appliances, and other processor-based devices. For example, FIG. 10 shows one example of a system 30 for performing one or more of the methods of the content messaging service system according to at least one embodiment of the invention. As shown, the system 30 can include at least one computing device, including at least one or more processors 32. Some processors 32 can include processors 32 residing in one or more conventional server platforms. In some embodiments, the system 30 can include a network interface 35a and an application interface 35b coupled to at least one processors 32 capable of running at least one operating system 34. Further, the system 30 can include a network interface 35a and an application interface 35b coupled to at least one processors 32 capable of running one or more of the software modules (e.g., enterprise applications 38). The software modules 38 can include server-based software platform that can include content messaging service software modules suitable for hosting at least one user account and at least one client account, as well as transferring data between one or more accounts.

Some embodiments of the invention also relate to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data are obtained over a network the data can be processed by other computers on the network, e.g. a cloud of computing resources.

With the above embodiments in mind, it should be understood that the invention can employ various computer-implemented operations involving content messaging service data stored in computer systems. Moreover, the above-described databases and models throughout the content messaging service can store analytical models and other data on computer-readable storage media within the system 30 and on computer-readable storage media coupled to the system 30. In addition, the above-described applications of the content messaging service system can be stored on computer-readable storage media within the system 30 and on computer-readable storage media coupled to the system 30. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Some embodiments include the system 30 comprising at least one computer readable medium 36 coupled to at least one data storage device 37b, and/or at least one data source 37a, and/or at least one input/output device 37c. In some embodiments, the invention embodied by the content messaging service system can also be embodied as computer readable code on a computer readable medium 36. The computer readable medium 36 can be any data storage device that can store data, which can thereafter be read by a computer system (such as the system 30). Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including processors 32).

In some embodiments of the invention, the computer readable medium 36 can also be distributed over a conventional computer network via the network interface 35a so that the content messaging service system embodied by the computer readable code can be stored and executed in a distributed fashion. For example, in some embodiments, one or more components of the system 30 can be tethered to send and/or receive data through a local area network (“LAN”) 39a. In some further embodiments, one or more components of the system 30 can be tethered to send or receive data through an internet 39b (e.g., a wireless internet). In some embodiments, at least one software application 38 running on one or more processors 32 can be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device.

In some embodiments, the network 39a, 39b can include wide area networks (“WAN”), direct connections (e.g., through a universal serial bus port) or other forms of computer-readable media 36, or any combination thereof. Further, in some embodiments, one or more components of the network 39a, 39b can include a number of client devices which can be personal computers 40 including for example desktop computers 40d, laptop computers 40a, 40e, digital assistants and/or personal digital assistants (shown as 40c), cellular phones or mobile phones or smart phones (shown as 40b), pagers, digital tablets, internet appliances, and other processor-based devices. In general, a client device can be any type of external or internal devices such as a mouse, a CD-ROM, DVD, a keyboard, a display, or other input or output devices 37c. In some embodiments, various other forms of computer-readable media 36 can transmit or carry instructions to a computer 40, including a router, private or public network, or other transmission device or channel, both wired and wireless. The software modules 38 can be configured to send and receive data from a database (e.g., from a computer readable medium 36 including data sources 37a and data storage 37b that can comprise a database), and data can be received by the software modules 38 from at least one other source. In some embodiments, at least one of the software modules 38 can be configured within the system to output data to a user 31 via at least one digital display (e.g., to a computer 40 comprising a digital display).

In some embodiments, the system 30 as described can enable one or more users 31 to receive, analyze, input, modify, create and send data to and from the system 30, including to and from one or more enterprise applications 38 running on the system 30. Some embodiments include at least one user 31 coupled to a computer 40 accessing one or more modules of the content messaging service system including at least one enterprise applications 38 via a stationary I/O device 37c through a LAN 39a. In some other embodiments, the system 30 can enable at least one user 31 (through computer 40) accessing enterprise applications 38 via a stationary or mobile I/O device 37c through an internet 39a.

In some embodiments, once the user has downloaded an application capable of communicating with the computer implemented content messaging service system, they can register on the content messaging service system. In some embodiments, service registration can be accomplished by an action of the user sending an email to register with the content messaging service system's own registration application. In some other embodiments, the user can proceed to register with a third-party social media system using an onboarding process. In some embodiments, the content messaging service system can allow a user to register either with another social network or create their own registration through email or some other unique identifier. For example, in some embodiments, a user can register using Facebook® credentials. In other embodiments, a user can register using Twitter® and/or Google+® credentials. In some embodiments, after the content messaging service system has created this unique account, the content messaging service system can enable a user to answer a series of questions that will help the system to identify their specific interests. In some embodiments, once complete, the content messaging service system can customize content based at least in part on the user's interest. “Facebook” is a registered trademark of Facebook, Inc., and “Twitter” is a registered trademark of Twitter, Inc.

In some embodiments, once the user chooses their method of registration and enters the appropriate credentials, the content messaging service system can make the appropriate decisions to ensure that it obtains the correct information to populate a new user content message account. After the account has been created, the user will be prompted to review and agree to contract terms and conditions for the service. The user can be presented with an option to agree to contract terms and conditions for the service. In some embodiments, registration will not be complete unless the user agrees to the contract terms and conditions.

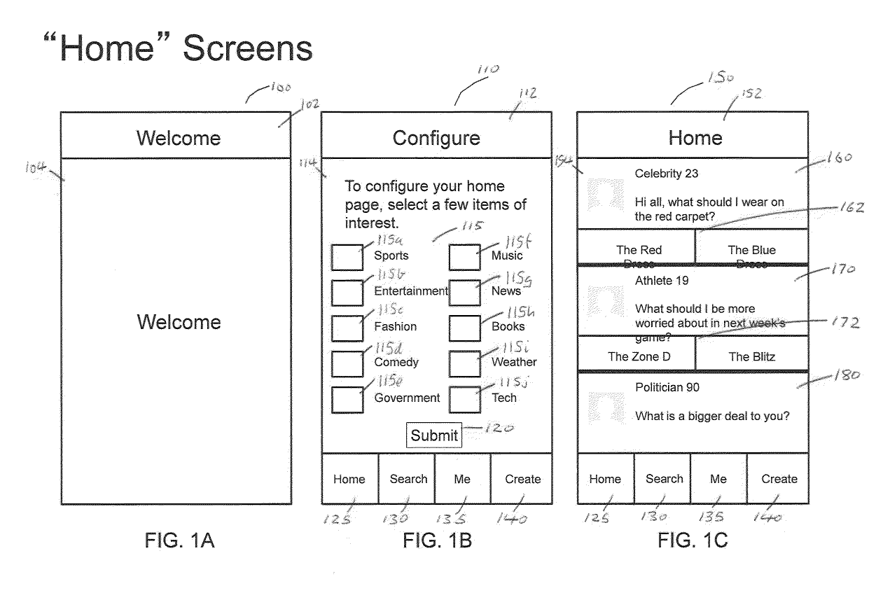

In some embodiments, once the user has properly installed a content messaging service application on their mobile device or other client device, agreed contract terms and conditions for the service, and has been approved as a registered user of the service, the user can be directed to the initial home screen (see home screen 100 shown in FIG. 1A). In some embodiments, the home screen 100 can comprise a header display 102 and a main display 104 that in some embodiments can comprise a welcome message. In some embodiments, the home screen 100 can allow the user to populate their home screen 100 with at least one content message. Referring to FIGS. 1B-1C, in some embodiments of the invention, the content messaging service system can display a home screen where each home screen can include a main display including a header display, and a plurality of access icons. In some embodiments, home screens 110, 150 can comprise various access icons including a “home” icon 125, and/or a “browse” icon 130, and/or a “me” icon 135, and/or a “create” icon 140. Other embodiments can include additional icons that can enable a user to enter additional information or navigate to further screens. In some further embodiments, different icons can be used, and the icons can be positioned differently than shown. In some embodiments, the access icons 125, 130, 135, 140 can be used by the user to access and direct various functions within the content messaging service system.

In some embodiments, a user can be allowed to pick from multiple categories of content within the content messaging service system. For example, FIG. 1B illustrates an example of a home screen 110 generated by a content messaging service system according to one embodiment of the invention showing various categories of content. The home screen 110 can comprise a header display 112, and a main display 114 that can include categories 115. In some embodiments of the invention, a user can review the categories 115 and select one or more of the categories (e.g., using one or more selection tick-boxes displayed adjacent a category name as depicted in FIG. 1B). Following a selection, the user can use a submit button 120 to submit one or more selected categories. In some embodiments of the invention, once selected and submitted, the content messaging service system can proceed to build a relevant home page based on the criteria selected. Some embodiments can include criteria comprising one or more categories including sports 115a, entertainment 115b, fashion 115c, comedy 115d, government 115e, music 115f, news 115g, books 115h, weather 115i, and/or science and technology 115j. In some other embodiments, further categories can be displayed and made selectable by a user within the main screen shown in FIG. 1B, or on a further screen accessible from the screen shown in FIG. 1B.

FIG. 1C illustrates an example of a home screen 150 generated by a content messaging service system according to one embodiment of the invention. In some embodiments, the home screen 150 can comprise a header display 152, and a main display 154 including information related to content messaging. In some embodiments, once a user posts a submission of category selection (using the aforementioned submit button 120), the content messaging service system can generate a home page 150 that can be populated with content messages from at least one HPP that falls into the one or more selected categories (i.e., any of the categories 115 selected by the user). In some embodiments, once a user is presented with a home page populated with the content messages, the content messaging service system can enable a user to perform various tasks from the home screen. For example, in some embodiments, a user can be provided with an option to view all content messages for all HPPs. In this instance, the information can be presented in a list format, and the user can scroll to view content messages that do not fit on the initial home screen. For example, FIG. 1C shows the content messages 170, 170, 180 associated with various voting options.

Some embodiments of the invention can enable a user to view one or more content message screens comprising one or more content messages. In some embodiments, once a user is presented with a home page populated with content messages, the content messaging service system can enable a user to view, select and vote for content messages. In some embodiments, once a user is presented with a home page 150 populated with content messages (e.g., content messages 160, 170, 180), the content messaging service system can enable a user to search specific information. For example, a user can be provided with the ability to search for content messages related to a specific HPP, a specific category, a specific content message author (including content messages authored by the HPP), as well as for content messages created or commented on within a specific time period. Furthermore, in some embodiments, a content message's popularity and associated rank can be displayed within at least a portion of a home screen (including for example within any portion of any of the examples of home screens shown in FIGS. 1A-1C). In some embodiments of the invention, a content message's popularity can determine how it is ranked against all other current content messages. Furthermore, in some embodiments, the higher its rank, the more prominently it will display on both the users' and HPP's home screens, and thus increasing its ability to get noticed and actioned. For example, in some embodiments, a content message's rank can be displayed on the home screen based on a ranking position. In some embodiments, a highly ranked content message can be more prominently displayed by displaying the content message and rank in a specific position on the home screen. In other embodiments, a highly ranked content message can be more prominently displayed by displaying the content message and rank in a specific format on the home screen. For example, in some embodiments, a highly ranked content message can be more prominently displayed by displaying the content message and rank using bolded text, underlined text, an increased font size, color text, animated text, or a combination thereof. In some other embodiments, a highly ranked content message can be more prominently displayed by displaying additional graphics with the content message and rank. For example, the content message and rank can be displayed within a rendered box or table, or mixed or overlaid with other static graphics, animated graphics, various colors, or combinations thereof.

In some embodiments, a content message can be displayed by the content messaging service system based on decay calculated by the content messaging service system. In some embodiments, a content message can be displayed by the content messaging service system based on a level of decay. For example, in some embodiments, a content message can comprise or be associated with a level of decay that defines, at least in part, the decay of the display of the content message by the content messaging service system. In some embodiments, a content message's decay can be depicted on the home screen. For example, in some embodiments, a newly created content message will appear at the top of all other users' home, new or various other screen types. However, in some embodiments, a content message's position representing a level of decay can change based on a variety of factors including, but not limited to addition of newly created content messages, a content message's age relative to its finite life, and a content message's rank.

Some embodiments of the invention can enable a user to view, select and vote for content messages. In some embodiments, any of the content messages displayed can include one or more voting icons. For example, in some embodiments, the main display 154 can include a voting icon 162 associated with the content message 160. In some further embodiments, the main display 154 can include a voting icon 172 associated with the content message 170. In some other embodiments, the main display 154 can include a voting icon associated with the content message 180 (not shown, however a user can scroll the main display 154 to bring the voting icon into view if required). As an example, in some embodiments, if a user selects or votes for a celebrity content message (e.g., any of the content messages 160, 170, 180 shown in FIG. 1C), the user can be directed to a “view content message” screen. Further, in some embodiments, a user can be enabled to vote via one or more buttons and/or icons displayed within the content message itself. In some embodiments of the invention, a vote action can be accomplished using a swiping action or function. For example, in some embodiments, the content messaging service system can provide a user the opportunity to swipe to vote on content. In some embodiments, the swipe can comprise a user swiping using an arm movement, a hand movement, a finger movement, or a combination thereof. In some embodiments, the user's device interface can recognize the swipe to perform at least one vote action within the content messaging service system. In some further embodiments, the swipe can comprise a user's movement on or across the user's device interface. Some embodiments can include a content messaging service system providing a user the opportunity to swipe using a swiping device (e.g., a wand, pen, or other hardware recognized by the user's device interface) to complete a voting action.

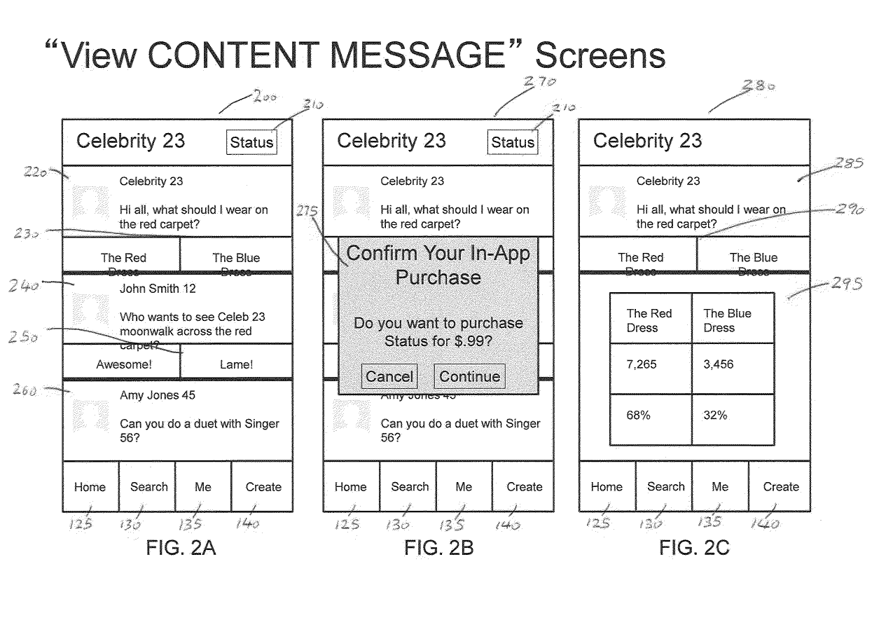

Referring to FIGS. 2A-2C, some embodiments of the invention include the content messaging service system processing and displaying one or more “view content message” screens. As depicted in FIG. 2A, in some embodiments, content messages from one or more users associated with a content message posted by an HPP can be displayed to a user. For example, the content message screen 200 can comprise a status icon 210, content messages 220, 240, 260, and associated voting icons 230, 250 (voting icon for content message 260 not shown but can be accessed by the user by scrolling as discussed earlier). In some embodiments, if an HPP creates a content message, it will receive special treatment in the rankings and automatically supersede other popular content messages for a specific period of time.

In some embodiments, the user can use an in-application purchase to obtain content message influence. In some embodiments, although the user will be able to view, search, browse, create, and vote after executing the download and registration, the user will not obtain any status on the content messaging service system unless they have purchased content message influence via an in-application purchase. In some embodiments, in order to obtain status, the user will need to make an in-application purchase for each HPP they wish to influence. As depicted in FIG. 2B, in some embodiments, when the user is viewing the content message screen 270, content messages associated with an HPP or brand, a “status” or “influence” button 275 can appear on the HPP or brand's homepage. In some embodiments, the content messaging service system can provide a user the opportunity to either click to complete the purchase through their app store account, or cancel the transaction.

In some embodiments of the invention, a user selection action can be accomplished using a gesturing function. For example, in some embodiments, the content messaging service system can provide a user the opportunity to gesture to complete the purchase through their app store account, or cancel the transaction, or vote on content. In some embodiments, the gesture can comprise an arm movement, a hand movement, a finger movement, or a combination thereof, and the user's device interface can recognize the gesture to perform at least one action within the content messaging service system. In some other embodiments, the gesture can comprise a user's eye movement, a user's blink, or a user's facial expression. In some further embodiments, the gesture can comprise a user's movement of the user's device interface. Some embodiments can include a content messaging service system providing a user the opportunity to gesture using a gesture device (e.g., a wand, pen, or other hardware recognized by the user's device interface) to complete the purchase through their app store account, or cancel the transaction.

In some embodiments, when users vote on the content of a content message, various vote types can be included on the platform star rating system, including but not limited to an alpha-numerical vote range (e.g., a voting scale of 1-10 or a choice of “A” or “B”), multiple choice answers, and free form answers with a choice of uniform response (e.g., 1, 2, 3, 4 or A, B, C, D). For example, the content message creator will be able to add content into answer choice “A” and answer choice “B”. Specifically, as an example, the “A” or “B” choice could be customized by the content message creator to “Red” and “Green”. Further, as illustrated in FIG. 2C, after a user votes on a specific content message, the user can view the aggregated results for all of the votes cast on that content message. For example, the content message screen 280 can include a content message 285 and at least one voting icon 290, along with aggregated result 295 showing voting statistics associated with the content message 285.

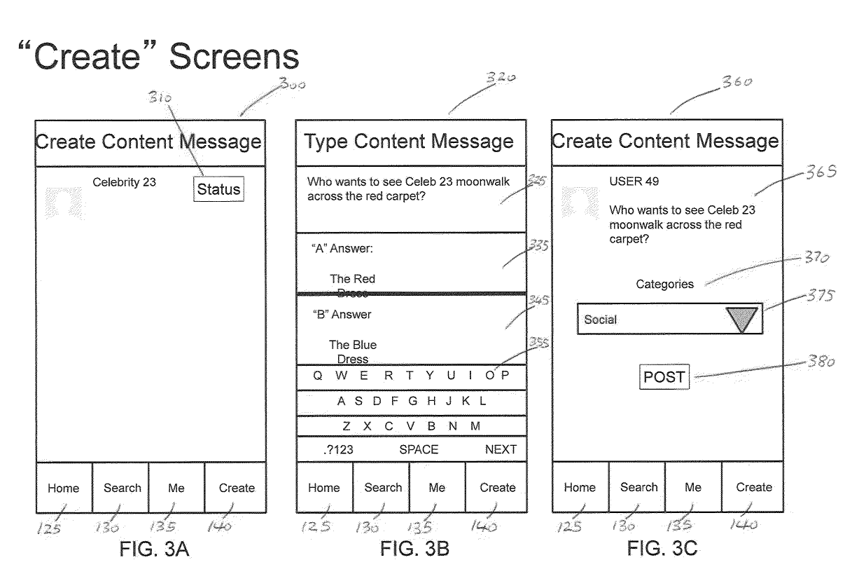

In some embodiments, if the user successfully purchases influence for an HPP, they can then be able to obtain status within the fan community associated with a specific HPP. For example, FIGS. 3A-3B illustrate examples of “create” screens generated by a content messaging service system according to one embodiment of the invention. In some embodiments of the invention, the create screen 300 can comprise a status icon 310, and the create screen 320 can include a content message 325 and one or more answers (e.g., answers 335 and answers 345). In some embodiments, after a user selects to initiate a content message from a content message-in screen for an HPP celebrity, the content messaging service system can enable a user to type a content message (e.g., a statement or a question). In some embodiments, the keyboard 355 can be displayed to enable a user to enter the content message. In other embodiments, the user can enter the message verbally, by using one or more touch icons, and/or using gestures.

In some embodiments, after the composition of a content message, the user can also be offered the ability to add other information including, but not limited to hyperlinks, pictures, video, audio, and other viewable and/or audible content. Further, as depicted in FIG. 3C, in some embodiments, the user can be presented with an option to select a category associated with their content message. In some embodiments, the category can be in the form of a drop down with pre-populated categories that match the original categories in the initial home page creation screen. For example, the create screen 360 can include a content message 365, a displayed category 370, and a selection tool 375 and post tool 380. In some embodiments, the selection tool 375 can be used to select the category 370 and the post tool 380 can confirm and enter the selected category.

In some embodiments, HPP's can be provided with automatic status access for all other HPPs, and they will not have to make in-application purchases. Further in some embodiments, HPP's can control the appearance and distribution of their content messages. For example, in some embodiments, an HPP can be provided with a veto function to alter, limit or remove one or more of their content messages. In some embodiments, a user will also be able to remove a content message from their own home, new or other pages if they no longer wish to view it. However, this will not remove it from any other user's pages (an HPP can remove messages from all user's pages). In some other embodiments, an HPP and an administrator can remove messages from all user pages.

Some embodiments of the invention can include other opportunities for in-application financial transactions. For example, in some embodiments, separate from the initial in-application purchase to achieve content message influence for a specific HPP or Brand, the content messaging service system can also provide be the ability to accept ongoing micropayments for special offers and services. In some embodiments, these special offers and services can include merchandise, tickets, hospitality opportunities such as “meet and greets”, charitable donations, VIP access to content or events, and music or movie purchase or pre-purchase

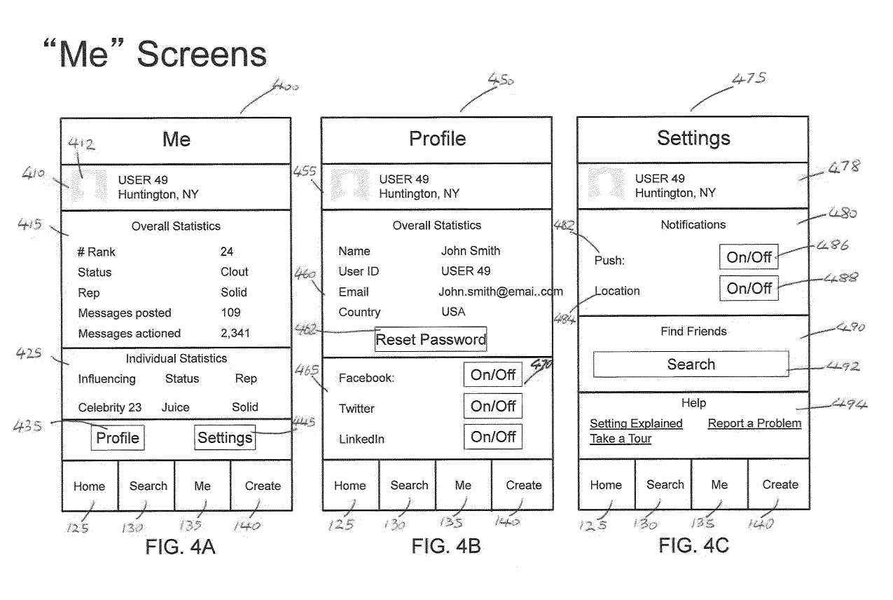

Some embodiments of the invention include providing a user the ability to change settings and perform a profile update. For example, FIGS. 4A-C illustrate various examples of a “me” screen generated by a content messaging service system according to one embodiment of the invention. As shown, in some embodiments, user settings and profile information can be managed by users to enable their settings and profile to be provided and/or updated within the mobile application. As illustrated in FIG. 4A, in some embodiments, the content messaging service system can display overall statistics of a user including a rank number, status and reputation of the user. For example, in some embodiments, the me screen 400 can comprise a user window 410, overall statistics window 415, and an individual statistics window 425. In some embodiments, the ranking information can include a group ranking within an HPP community as well as a global rank, a thumbnail picture 412 of the user (or other user-selected image), and an email log-in option. Moreover, the display can also include content message statistics including the number of content messages posted and the number of content messages actioned, as well as individual statistics related to any HPP. For example, in some embodiments, the display can include the HPP being influenced, the user status, and the reputation. In some further embodiments, the display can also be populated with suggested HPP's to follow based on current HPP's subscribed and/or HPP interactions. In some embodiments, the “me” screen can also include historical information related to the length of membership, and user statistics including the average time spent using the system. In some embodiments, any profile analytics displayed can be based on keywords and HPP's followed.

In some embodiments, any one of the data fields illustrated in FIGS. 4A-4C and described can be optionally filled out by or for the user. Moreover, some embodiments include incentives to fill out data. For example, in some embodiments, the content messaging service system can display information configured to incentivize a user (e.g., in order to gain more status, unlock special questions, claim offers from brands and HPP's, etc.). In some embodiments the display can include profile and settings icons to enable a user to navigate to one or more profile and settings screens. For example, FIG. 4A illustrates a profile and settings icon (profile icon 435 and settings icon 445). In some embodiments, when a user selects the profile icon, the content messaging service system can display one or more profile screens.

Referring to FIG. 4B, illustrating an example of a “profile” screen 450 generated by a content messaging service system according to one embodiment of the invention. In some other embodiments, when a user selects the settings icon 445, the content messaging service system can display a screen 475 shown in FIG. 4C which illustrates an example of a “settings screen” generated by a content messaging service system. As illustrated, in some embodiments, the profile screen shown in FIG. 4B can include a user identification and general location information. In some embodiments, the profile screen 450 can include a user profile within a user window 455 that can include a user's name, their email address and country of residence and/or nationality. In some embodiments, the profile screen 450 can include functionality to enable a user to change a password. For example, the profile screen 450 can include an overall statistics window 460 that includes a reset password icon 462.

Some embodiments include options for linking to one or more social media platforms. For example, the profile screen 450 can include a social media linking window 465 that comprises one or more toggle icons 470 to toggling (e.g., turning on and turning off) linking to one or more social media platforms. As discussed earlier, in some embodiments, service registration can be accomplished by the user registering with a third-party social media system including Facebook® and/or Twitter®. As shown, the user can also be provided with an option to be connected through LinkedIn®, and the user can select or deselect the social media connection (for example using an “on/off” slider control). Moreover, some embodiments of the invention can enable social distribution and in-app networking of user content including content messages posted by users and/or HPPs. For example, in some embodiments, fans will have the ability to link their content message activity to an number of social media platforms such as by a post to Facebook®, Twitter®, Google+®, Instagram® and others. Through a content message API, HPP's and fans will be able to post a content message icon in their blog, webpages, feeds or other means for distribution and linking content. In some further embodiments, fans can contact each other within the content messaging service system via direct and private messaging, and can be enabled to follow each other through the content messaging service system to see what they are posting and be notified when they are active on the content messaging service system. In this instance, direct and private messaging and fan tracking can be enabled directly through the content messaging service system on a peer-to-peer basis and/or through any one of the social network platform distribution channels described above.

Google, the Google logo and the Google+® social service are registered trademarks of Google Inc. The Instagram® name and logo are trademarks of Instagram, Inc. LinkedIn® is a registered trademark of LinkedIn Corporation.

In some embodiments, the “settings” screen can include a notifications region. For example, as illustrated in FIG. 4C, in some embodiments, the content messaging service system can provide a push notification option and a location notification option. For example, the settings screen 475 can comprise a user window 478 and a notifications window 480. In some embodiments, the notifications window 480 can include the push 482 type notification and/or a location 484 type notification. Further, in some embodiments, the push 482 type notification can be associated with an on/off selector 486, and the location 484 type notification can be associated with an on/off selector 488. In some embodiments, either option can be turned off or on by the user.

In some embodiments of the invention, the content messaging service system can enable a user to find at least one friend. In some embodiments, the content messaging service system can enable users to find their friends on the content messaging service system and follow them. In some embodiments, the content messaging service system can recall a user's login credentials from another social network, and check the database to match which of their friends and/or followers are also part of content messaging service system. In some embodiments, once that matching process has occurred, the content messaging service system can display all matches that the user can then add to their own following. In some embodiment of the invention, the content messaging service system can allow for the integration of multiple social networks into the same list view. For example, in some embodiments, if a user logs in with Facebook®, but has also granted the content messaging service system permission to access their Twitter® account, the system will display both Facebook® and Twitter® friends/followers in the same view. In some embodiments, the settings screen 475 can also include a find friends search field that can enable a user to search for friends. For example, in some embodiments, the settings screen 475 can comprise a find friends window 490 and a search icon 492 that can enable a user to search for one or more friends. In some further embodiments, the settings screen 475 can also include a help region including options to enable a user to determine the meaning of specific settings, engage in a tour of one or more features of the content messaging service system, and to enable a user to report a problem. For example, in some embodiments, the settings screen 475 can comprise a help window 494 that can be used by a user to access at least one help function or help information.

In some embodiments of the invention, the content messaging service system can enable a user to invite one or more friends to the content messaging service system. For example, in some embodiments, the content messaging service system can allow a user to invite friends to the network. In this process, the user can click on an “Invite friends” button which will scan their contacts, and then display their contacts. In some embodiments, this list can include a button next to each contact that the user can click to invite, or an “invite all” button.

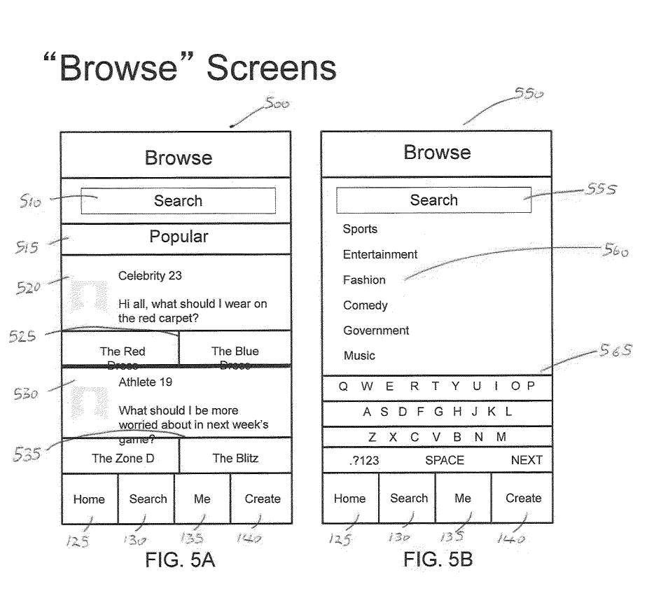

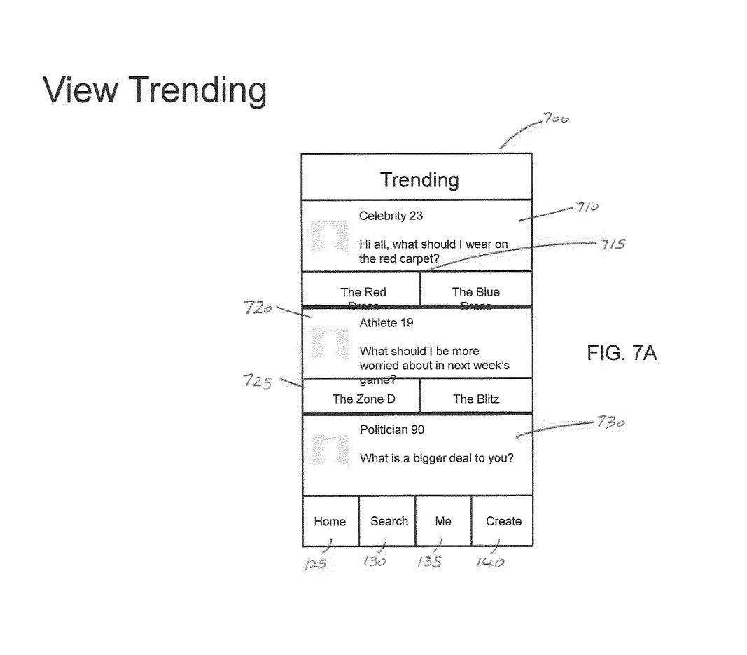

Some embodiments of the content messaging service system can enable a user the ability to view and browse tables of information related to content messages from various tables of content message information. For example, FIGS. 5A and 5B illustrate an example of a “browse” screens 500, 550 generated by a content messaging service system according to one embodiment of the invention. In some embodiments, top content messages can be browsed and viewed, providing a user with the ability to view the top content messages related to an HPP, or a category. In some further embodiments, trending information can be viewed and browsed, including for example providing a user with the ability to view trending content messages (those gaining popularity most quickly). For example, FIG. 7A illustrates an example of a “view trending content messages” screen 700 generated by a content messaging service system according to one embodiment of the invention. The screen 700 can include a content messages 710, 720 and associated voting icons 715, 725. As illustrated, in some embodiments, trending content messages (e.g., content messages 710, 720) can be viewed and browsed for one or more HPPs, including for example providing a user with the ability to view trending content messages as a function of time. In some embodiments of the invention, the content messaging service system can display a graphic of content messaging service system messages based on the categories and sub-categories they were written under. In some embodiments, this graphic can be static or updated in real time. In some embodiments, the size of the each category or sub-category icon will be dependent on the number of votes it has received over a period of time. In some embodiments, the size of each category or sub-category icon will be dependent on the number of content messaging service system messages written.

In some other embodiments, information related to content message popularity can be viewed and browsed, including for example, a user can be provided with the ability to view the most popular content messages. As depicted in FIGS. 5A and 5B, the search and subsequent results browsing can be HPP or category related, and can in some instances include HPP authored content messages. For example, browse screen 500 can include a search icon 510 and a popular window 515 that can comprise a content message 520 with associated voting icons 525, and a content message 530 with associated voting icons 535. Referring to FIG. 5B, the browse screen 550 can include a search icon 550 and a categories 560. The categories 560 can include sports, entertainment, fashion, comedy, music or news. In some other embodiments, other categories can include: day, time, all-time, “fast-mover”, editor's choice, answered, and cars, food, lifestyle, fashion, beauty, etc. In some embodiments, the keyboard 565 can be displayed to enable a user to enter the content message. In other embodiments, the user can enter the message verbally, by using one or more touch icons, and/or using gestures.

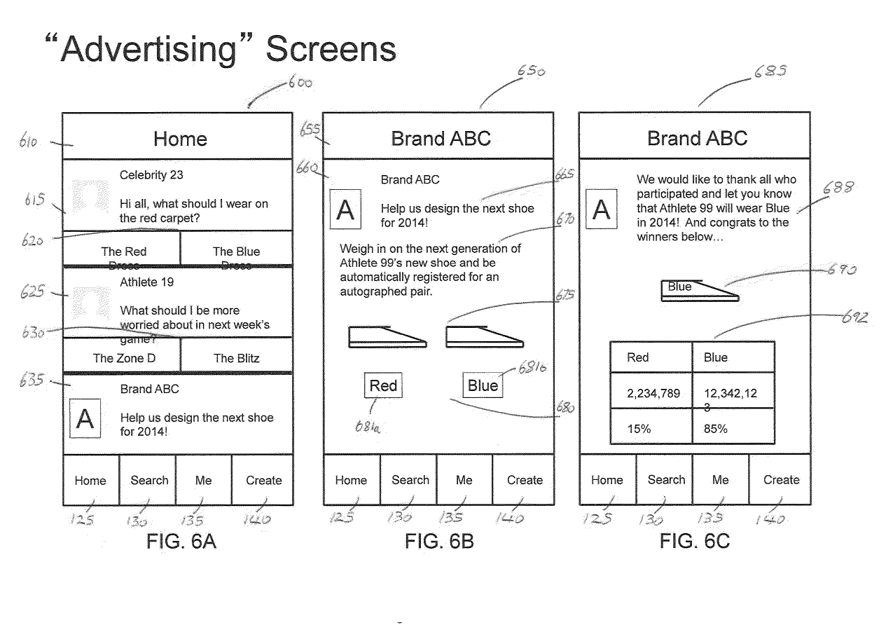

Some embodiments of the content messaging service system can include at least one advertisement. For example, FIGS. 6A-6C illustrate examples of “advertising” screens generated by a content messaging service system according to one embodiment of the invention. Some embodiments can comprise platform advertising and can include at least one targeted ads based on location, or key attributes, including for example genre, keyword search, Facebook® or Twitter® fed data, and/or other unique identifiers. In some embodiments, the “advertising” screen generated by a content messaging service system can include native ads, and can include in feed brand content messages ads with call to action. In some embodiments, brands can create their own content message HPP persona in which fans of the brand can look to influence the brand. Additionally, in some embodiments, the brand will be able to create content messages for fan interaction. In some embodiments, the users will be able to create content messages free of charge as an option if brands so choose. Some embodiments can include load screen branding, and direct messages from brands to users. Some embodiments can include free sign-ups for certain HPP's who want to generate a larger following.

In some embodiments, ads can include special offers and/or alerts for discounts from advertising or brand partners. Some embodiments can include event or appearance alerts with HPP's or brands, (e.g., flash mobs, live performances, major sales, giveaways). In some other embodiments, ads can include coupons for discounts at retailers or other merchants. In some embodiments, one or more offers can be targeted by the status group, and a note can be sent only to users who have achieved a certain level status on the content messaging service system.

Some embodiments of the invention can comprise one or more electronic focus groups. In some embodiments, the content messaging service system can include methods that can allow HPPs to create unique focus groups to provide valuable feedback on questions from the HPP. In this instance, the content messaging service system enable HPPs to create focus groups to enable valuable feedback on product decision making, to provide fashion and styling suggestions, likability of content such as film, TV productions, commercial productions and to drive foot traffic to physical world locations for input.

Referring to FIG. 6A, in some embodiments, the content messaging service system can display a content message screen including at least one ad. In some embodiments, the advertising screen 600 can comprise a home header 610, content message 615 and associated voting icons 620, and/or content message 625 and associated voting icons 630. In some embodiments, an ad can be included as a brand window 635. Referring to FIG. 6B, in some embodiments, the content messaging service system can process and display an advertising screen 650 that includes a brand window 655. In some embodiments, the screen 650 can comprise a brand display 660 with a content message 665, and/or content message 670, and voting icons 675 and/or voting icons 680. In some embodiments, if a user selects the ad, the content messaging service system can provide a user with an option to content message based on a question within the ad. In some embodiments, once a user provides a response to an ad question (e.g., by selecting answer 681a or 681b), the user can be shown statistics related to questions and answers provided in the ad (e.g., see FIG. 6C). FIG. 6C illustrates an example of an “advertising” screen 685 generated by a content messaging service system according to one embodiment of the invention. In some embodiments, the screen 685 can comprise content message 688 and a results icon 690. Further, a results table 692 can be shown with statistics related to questions and answers provided in the ad referring to in FIG. 6B.

Some embodiments of the invention can enable a user to organize content messages. For example, FIG. 7B illustrates a screen 740 generated by a content messaging service system including message organization options according to one embodiment of the invention. The screen 740 can comprise a browse header 745, a search icon 748, and a content category 750. In some embodiments, a user can organize content messages based on a chosen category (with the example in FIG. 7B showing a selected category based on “Athletes” in content message 765). In some other embodiments, the user can organize content messages (such as content message 755 and associated voting icons 760, and content message 765 and associated voting icons 768) based on a variety of other factors including, but not limited to chronology, level of activity, and status.

Some embodiments can enable a user to monitor their status within multiple HPP communities. For example, FIG. 7C illustrates an example of a screen 770 generated by a content messaging service system including information for keeping track of a user's status within multiple HPP communities according to one embodiment of the invention. As illustrated in FIG. 7C, in some embodiments, the content messaging service system can display overall statistics of a user including a rank number, status and reputation of the user. For example, the screen 770 including a me header 772 can comprise a user window 775 with an overall statistics window 780, individual statistics window 785, and a user selectable profile icon 788 settings icon 792. Further, in some embodiments, the ranking information can include a group ranking within an HPP community as well as a global rank. Moreover, in some embodiments, content message statistics including the number of content messages posted and the number of content messages actioned can be displayed and viewed in addition to individual statistics related to any HPP. For example, in some embodiments, the display can include the HPP being influenced, and the user status and reputation.

Some embodiments of the content messaging service system can enable a user to create messages in the form of ideas and questions with uniform answers. For example, FIG. 7D illustrates an example of a screen 794 generated by a content messaging service system for creating direct messages in the form of ideas and questions with uniform answers according to one embodiment of the invention. In some embodiments, the screen 794 can comprise a create content message screen 794 including a create content message window 794a with user info 796, and/or content message 796a. Further, in some embodiments, the screen 794 can comprise categories 797, and a selection tool 798 and post tool 799. As described earlier, some embodiments of the invention can enable a user to vote on the content of a content message comprising free form answers with a choice of uniform response. In some embodiments, a user can select a category (from the selection tool 798) and post a content message aligned to the category. In some embodiments, a user can write comments on content messages which will be displayed in a chat room created around a certain trending content message or HPP. In this instance, the community can be enabled to free form comment without disturbing and/or crowding the overall messaging sessions. In some embodiments, comments can be posted to other social media sites or websites via API's.

Some embodiments of the invention enable manual and/or automated content filtering. For example, some embodiments enable the content messaging service system to filter comments based on profanity, bullying and inappropriate behavior via fan interaction. Some embodiments of the content messaging service system also provide buttons and/or icons to enable a user or HPP to report platform misuse to a content message product team member. In some embodiments, if a user ceases to use the content messaging service system for a period of time, or is continually flagged for inappropriate commentary, their status will decay and in some cases they can be kicked off the content messaging service system.

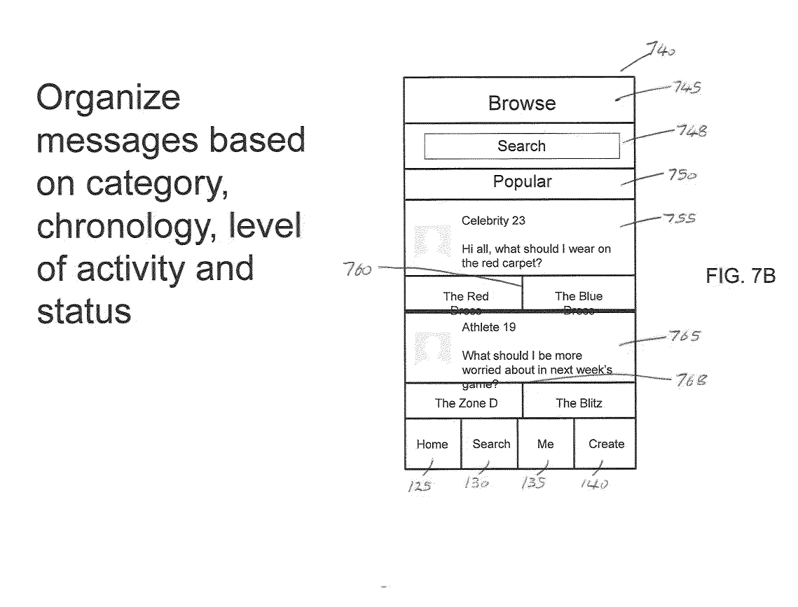

As discussed earlier, the content messaging service system can utilize a ranking system so that a highly ranked content message can be more prominently displayed to a user. This concept is illustrated in FIG. 8A which depicts one example definition of a content message according to one embodiment of the invention. In some embodiments, the ranking system can be used to rank and prioritize the content messages created and shared amongst a community of users and can include free form messages and uniform responses. For example, in some embodiments, the content message definition 800 can comprise a free form message 810 at least partially overlaid with a uniform response 820, and at least partially overlaid with a rating system 830. In some embodiments, the content message 840 can be defined by at least one of the free form message 810, uniform response 820, and the rating system 830.

In some further embodiments, the content messaging service system can utilize a content message logic ranking and status system. In general, a user's ultimate goal in creating a content message is to get it in front of an HPP and solicit an action and/or a response. However, with potentially thousands of content messages created per day, a logic-based ranking system must exist to allow HPPs and users to sort and view only the most popular and interesting content messages. In some embodiments, the content message logic ranking and status system can assign an author's status so as to determine and assign a content message's popularity. In this instance, not only will this status influence a specific content message's ranking, but it will reflect on the author for all of their content message interactions within the community. From a user's standpoint, it can be desirable to become a popular author of content messages as a user's status will earn them the ability to keep content messages in front of an HPP for a longer period of time, and allow other users to see their importance in the content message community.

In some embodiments, there can be four levels of status termed “pull”, “juice”, “clout”, and “top” (where “top” can be the highest rank, and “pull” is the lowest rank). In some alternative embodiments, the four levels of status can include different naming for each level of status. In some embodiments, status is earned through various user related parameters including time spent and engagement on the content messaging service system, amount of recognition a player gets from others in the community, and whether they get noticed by the HPP. In some embodiments, the key to achieving a higher status can include crafting interesting questions and statements (content messages) that the whole community can want a reaction to from their HPP. In some embodiments, the more insight into a HPP the user brings to the community, the better status the user will have.

For instance, FIG. 8B shows a content message status diagram 850 according to one embodiment of the invention. As shown, in some embodiments, the status categories can include “top” 865 in which the HPP 860 knows who the user is and/or has responded to one of your content messages directly. Some embodiments can also include a status category of “clout” 870, which is defined as a user having a status of the upper echelon of the community. In this instance, the HPP 860 has most likely seen your content message but has not responded. Some embodiments can include a status category of “juice” 875, which is defined as a user having a status of an active user of the service, but have not been noticed by the HPP 860. However, in this case, other users have seen and responded to your content messages. In some further embodiments, a content message category can include a status category of “pull” 880. In this instance, the user can be assigned an ability to reach out to the HPP 860, but in this instance, contact has been limited.

In some embodiments, after a user downloads content message access for a specific HPP, the user becomes an “influencer” and can be enabled to create as many content messages as they would like associated with that specific HPP and earn status in doing so. In some embodiments, once the user designs and creates a content message, the user can click or gesture to “Submit”. At this time, the content message information will be recorded on a server by the content messaging service system, and tagged and associated with the HPP. In some embodiments, the content messaging service system can manage the content message so that it is viewable by all other content message influencers of the HPP. In some embodiments, the new content message will go into the “new” bucket and remain in it for a period of time. Moreover, voting for a content message will be limited to a fixed period of time. At this time the goal for the content message's author (the user) is to make the content message popular so it can move to the “popular” bucket (shown in FIG. 7B), which is typically where the HPP and other users will look for content messages to respond to.

Some embodiments of the content messaging service system can manage the content message logic and ranking using various algorithms. For example, in some embodiments, the popularity of a content message (“P”) can be determined by the following formula:

# of responses (“R”)×author's status (“S”)×decay (“D”)=P

In some embodiments, all content message popularity values are compared to one another in real-time and then ranked by the content messaging service system. The content message with the highest value (“P”) will achieve the #1 rank, the next highest will achieve the #2 rank and so on. In some embodiments, the # of responses (“R”) relates to a driving force behind the popularity of a content message based on how many other users view and action it. In some embodiments, if a content message is interesting to the content message community, it will be actioned (i.e., someone will click or gesture a response) and therefore gain popularity. If it is not, it can be ignored and can lose popularity.

In some embodiments, in order to calculate a first part of the popularity calculation (“P”), the content messaging service system can compute a simple whole number value based on the total number of responses a content message receives during its voting life span. In some embodiments, the more responses a content message receives, the more interesting it is to the audience, and therefore the more popular it becomes. For example, in some embodiments, the current number of responses associated with 5 content messages that were written in a week for a specific HPP can include two responses for content message 1, seventeen responses for content message 2, thirty one responses for content message 3, nine responses for content message 4, and forty one responses for content message 5. In some other embodiments, the current number of responses associated with 5 content messages that were written in a week for a specific HPP can include other combinations of values.

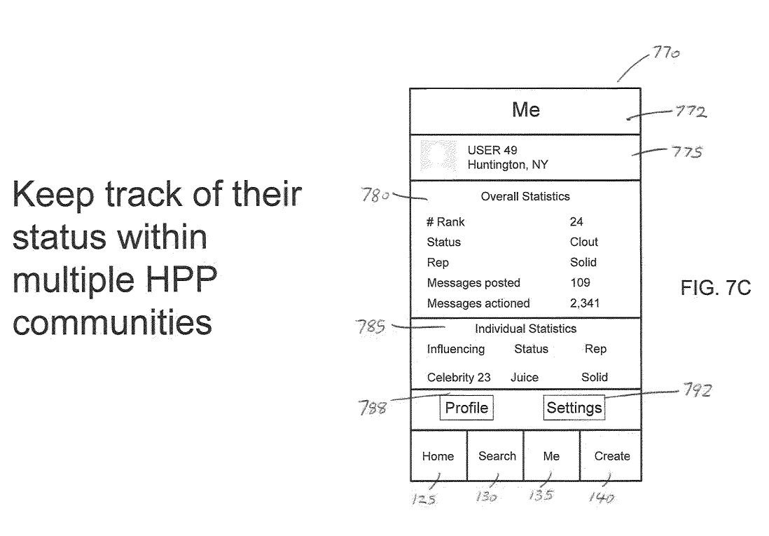

Some embodiments can also include a content message's popularity calculation for a current week. For example FIG. 9A shows one example of a content message status calculation 900 according to one embodiment of the invention showing a score and status value calculated for each of the status categories (as defined in FIG. 8B). The content message status calculation 900 can comprise a status category 910 (comprising “top” 865, “clout” 870, “juice” 875, and “pull” 880), score 920, and status value 930 assignments for each of the status category 910). In some embodiments, for “top” 865, with a score of greater than 200 or response from HPP, the status value can be assigned as 4. Further, in some embodiments, for “clout” 870, with a score of 101-200, the status value can be assigned as 3. Further, in some embodiments, for “juice” 875, with a score of 51-100, the status value can be assigned as 2. Further, in some embodiments, for “pull” 880, with a score of 0-50, the status value can be assigned as 1.

Further, FIG. 9B shows one example of a user's status calculation 950 according to one embodiment of the invention. In some embodiments, to determine a user's status, the total score is compared using the below formula (over a past week):

(# of content messages created×X %)+(# of user responses×Y %)+(# HPP responses×Z)=Value

where the variables X % and Y % are weighting factors that can range between 0 and 100%, and Z is a weighting factor that can range between 0 and 100. In some further embodiments, at least one of the weighting factors X %, Y % and Z can include other numerical ranges.

FIG. 9B shows one example of the status calculation for five users, showing content messages composed, content message responses, a raw score, an HPP response, total and status for each user. For example, the user's status calculation 950 can comprise statistical information categories 960 including messages composed 962, and/or messages responses 964, and/or raw score 966, and/or HPP response 968, and/or total 970 and/or status 972. In some embodiments, the content and messaging service system can assign weight 975 to messages composed 962 and messages responses 964, and/or HPP response 968. Further, in some embodiments, the content and messaging service system can process values for one or more users 980 within the user's status calculation 950.

As discussed earlier, in some embodiments, a content message can be displayed by the content messaging service system based on decay calculated by the content messaging service system. In defining a decay (“D”), initially a newly created content message will appear at the top of all other users' home, new or various other screens. In some embodiments, users can then view the content message, and respond to it if they so choose. However, in some embodiments, as newer content messages are created, the previous content message will begin to drop down on the list. Additionally, in some embodiments, each content message has a finite life, and its relevance erodes over time. Therefore, in some embodiments, content messages will experience content message decay, which is the process of decreasing a content message's rank over time as it becomes more stale and less relevant. As previously stated, a content message's total voting life is 1 week from the date of submission. Therefore, if all else is equal, a content message's popularity decays at a constant rate of 14.2% per day (or −14.2% in the calculation disclosed above). In some embodiments, a user can slow the rate of a content message's decay they have authored based on their overall status. In some embodiments, more popular authors'content messages decay at a slower rate than less popular authors' content messages. This provides incentive for users to achieve a higher status.

FIG. 9C shows a table 985 detailing the decay bonus earned based on the author's status, and includes the decay bonus value 987 as a function of the status category 986. FIG. 9D shows a table 1000 detailing content message (shown as list 1030) ranking calculations according to at least one embodiment of the invention. Within the embodiments as illustrated, the content messaging service system can include ranking calculation information at least including a content message submission time (1005), the number of responses (1008), the author rank (1009), and the rank bonus (1010). The ranking calculation information can also include the raw score (1011), and decay information including time decay (1012), rank decay bonus (1013), and today's decay (1014) in addition to a today's weighted raw (1015), and a today's rank (1020). As an example, if a content message decays at 14.2% per day, but the author's status is “clout”, the decay will be halted for a total of 2 days.

Some embodiments of the content messaging service system can include a variety of other services and attributes. For example, in some embodiments, the content messaging service system can comprise location based services designed to enable a user to find content message members and HPPs based on location. In this instance, the content messaging service system can aggregate data points around usage based on location. In some embodiments the content messaging service system can allow for fan “meet ups” based on proximity/location, and alerts can be sent if location based services are activated on a mobile device. Further, in some embodiments, the content messaging service system can send alerts if an HPP would like to drive a fan to a location for discounts, flash events, or other promoted events.

Some further embodiments of the invention can include enabling a user to create a new group. For example, in some embodiments, the content messaging service system can allow users to create a group around an HPP even if the HPP has not previously signed up for services. In some embodiments, this feature can provide a lobbying service to try and entice a new HPP onto the content messaging service system after their fan base has already been built on the content message platform.

Some embodiments can include alerts comprising push notifications for HPP actions, user interaction to posted content messages, and notification for when other fans have posted new content messages. In some embodiments, alerts can be generated based on posts to Facebook® and/or Twitter®, or other social media sites that are sharing HPP updates. In some other embodiments, alerts can comprise targeted alerts (based who is on the content messaging service system). In some other embodiments, alerts can comprise a special message by category, i.e. autos, cooking, etc.

Some embodiments of the content messaging service system can enable HPPs to collect and analyze all data related to their content message activity. For example, in some embodiments, HPPs can collect information that can contain at least content message community member information (names, location, interests for example), total content messages authored, total content messages responded to, content message response rate, message categories and content message statistics (vote count), and all chat activity related to their likeness. Moreover, in some embodiments, the content messaging service system can produce an aggregated report detailing their community demographic.

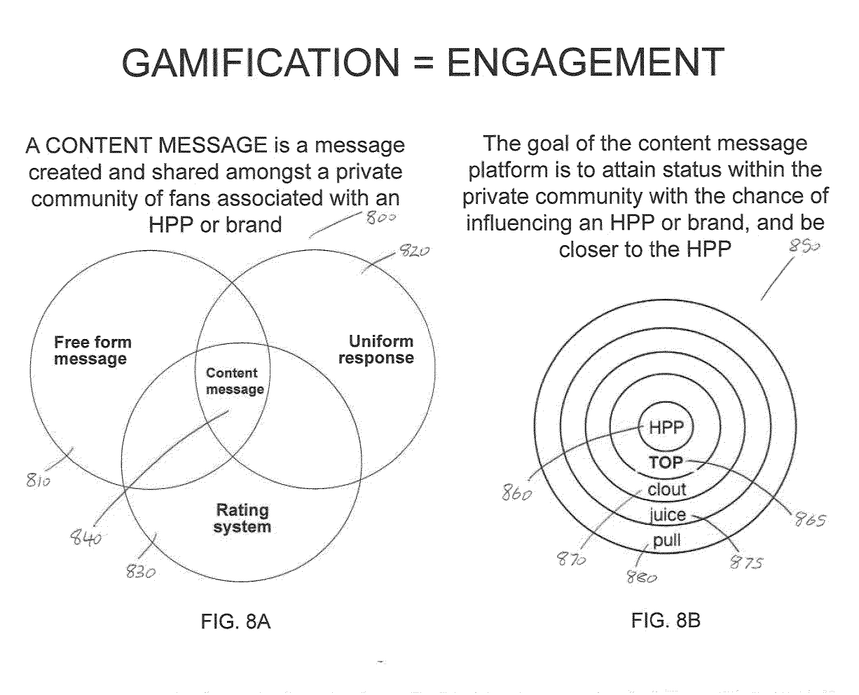

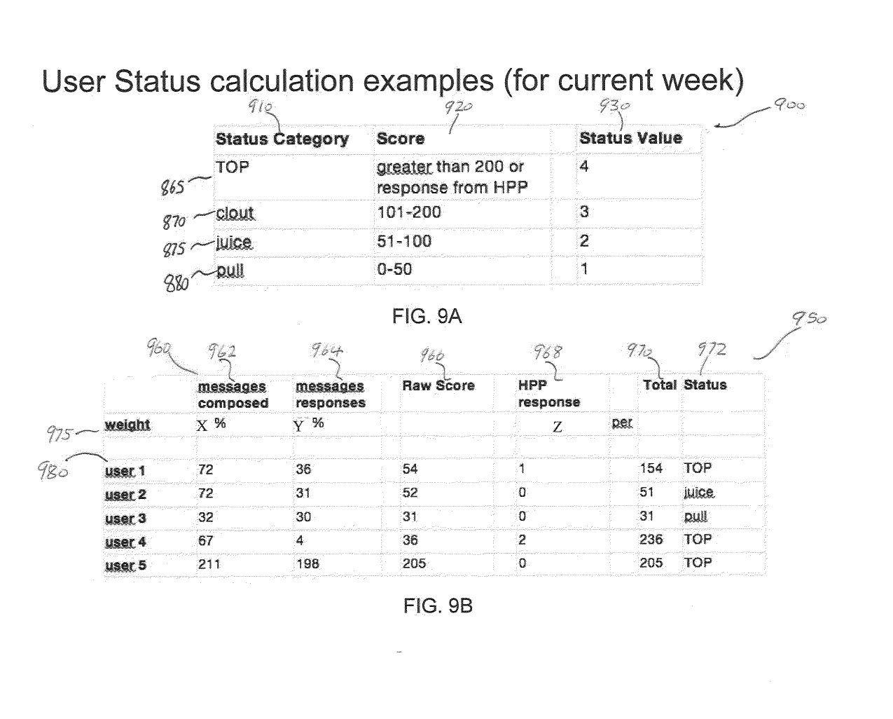

As described earlier, in some embodiments, the content messaging service system can enable a user to select categories of content. A user can review the categories 115 and select one or more of the categories (depicted in FIG. 1B). Following a selection, the user can use a submit button 120 to submit one or more selected categories. In some embodiments, the content messaging service system can enable a user to determine manually or systematically what categories are most popular based on votes, clicks, views, comments, shares, saves or other variables. In some embodiments, the content messaging service system can enable a user to display those categories in an order to highlight the best and most trending messages based on the above variables. In some further embodiments, the content messaging service system can enable a user to determine manually or systematically what sub-categories are most popular based on votes, clicks, views, comments, shares, saves or other variables. For example, FIG. 11 illustrates a trending topics and search display comprising a trending and topics search screen 1100 and including a trending topics list 1110. In some embodiments, the content messaging service system can enable a user to display those sub-categories in an order to highlight the best and most trending messages based on the above variables. For example, FIG. 12 illustrates a featured sub-categories display in accordance with some embodiments of the invention. The featured sub-categories display can comprise a featured sub-categories screen 1200 that comprises a feeds 1210 and access to one or more content pages including, but not limited to, trending page 1220, categories page 1230, following page 1240, and private page 1250. In some embodiments, the featured sub-categories screen 1200 can comprise a featured display 1260 (e.g., comprising a specific sub-category). In some further embodiments, the featured sub-categories screen 1200 can also comprise a window 1270 that in some embodiments can enable a user to control the content or action of the featured display 1260.

In some embodiments, the content messaging service system can enable a user to further display and rank content and content messaging service system polls by sub-category. These sub-categories can be permanent or ephemeral. In some embodiments, the content messaging service system (e.g., through one or more back end architecture components of the system 30) to create, display, modify and delete sub-categories in real time.

In some embodiments, the content messaging service system can process sub-categories that can be accessible from a home page, navigation menu or other areas of the service including search (e.g., through home screens depicted in FIGS. 1B-1C, and/or by accessing icons 125, 130, 135, 140). In some embodiments, if a user clicks on a sub-category, content from that sub-category can be displayed to the user. In some embodiments, the user can rank the content chronologically or by popularity. Further, the content messaging service system can include a provision to manually set where content created for a sub-category is viewable by all users in some embodiments, or a certain sub-set of users in some other embodiments. In some embodiments, the content messaging service system can process sub-categories that can be used for live events or other ephemeral content. By utilizing sub-categories for this purpose, it is possible that content can be created in a sub-category and not be viewable in the main feed.

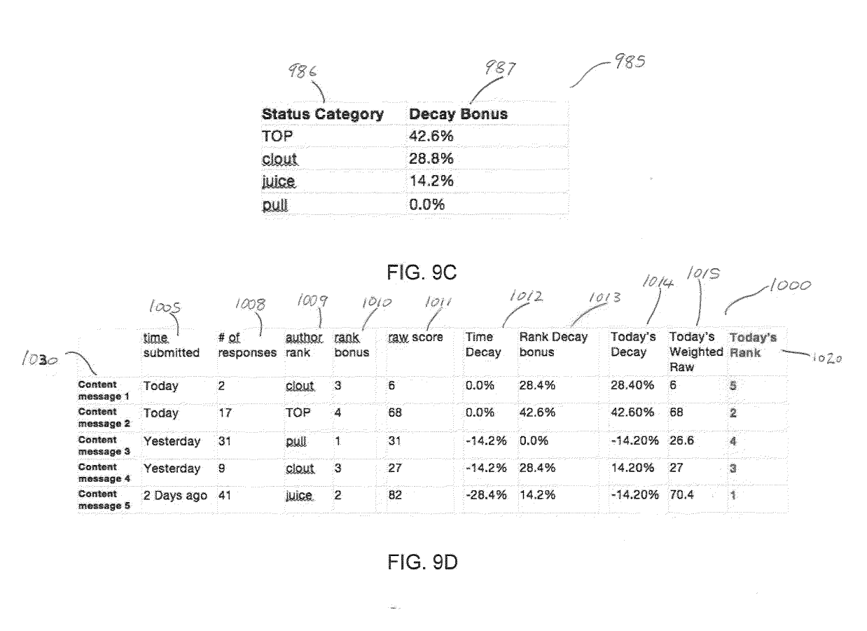

In some embodiments, the content messaging service system can enable users to save content messaging service system messages so they can retrieve and view them at a later time. In some embodiments, these messages can be housed and displayed in a separate “Saved” category. For example, FIG. 13 illustrates a saved messages display (saved window 1300) of the content messaging service system in accordance with some embodiments of the invention. In some embodiments, the saved window 1300 can comprise saved messages 1310. Further, the saved window 1300 can include a content message 1320 in some embodiments.

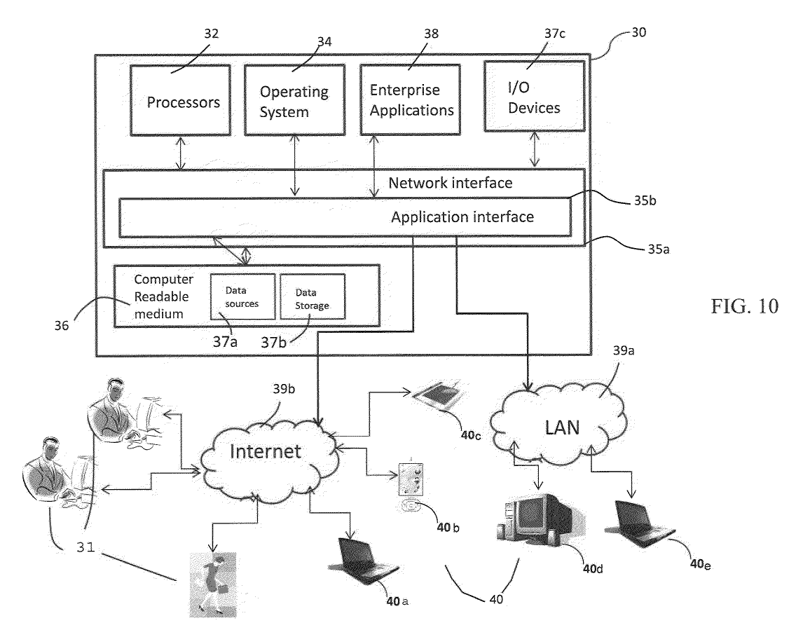

As described earlier and shown in FIG. 4C, the content messaging service system can provide a location notification option where the settings screen 475 can comprise a user window 478 and a notifications window 480. In some embodiments, the notifications window 480 can include the push 482 type notification and/or a location 484 type notification. In some further embodiments, the content messaging service system can allow users to view a list of notifications that include vote achievements, new followers, new friends that have joined the content messaging service system, a new category or sub-category was added or, a live event was happening. These notifications can also be deleted. For example, FIG. 14 illustrates a notifications display in accordance with some embodiments of the invention. In some embodiments, the notifications screen 1400 can comprise a past display 1410 that can display at least one prior notification.

In some embodiments, the content messaging service system can enable users to create private content messaging service system messages that are only viewable by users that select to see the message. In some embodiments, the content messaging service system can also enable users to see who else received a private message. In some embodiments of the invention, after a user has created a message, the user can mark it “private”, and specify recipients of the message from a list of contacts that are populated by the content messaging service system. In some embodiments, the content messaging service system can enable users to create their own private sub-categories or “channels” and invite others to participate. In this process, the content messaging service system can enable a user creating a new private channel to follow a process in which they can name the channel, add a profile photo to the channel, and select a group of users who can gain access to the channel.

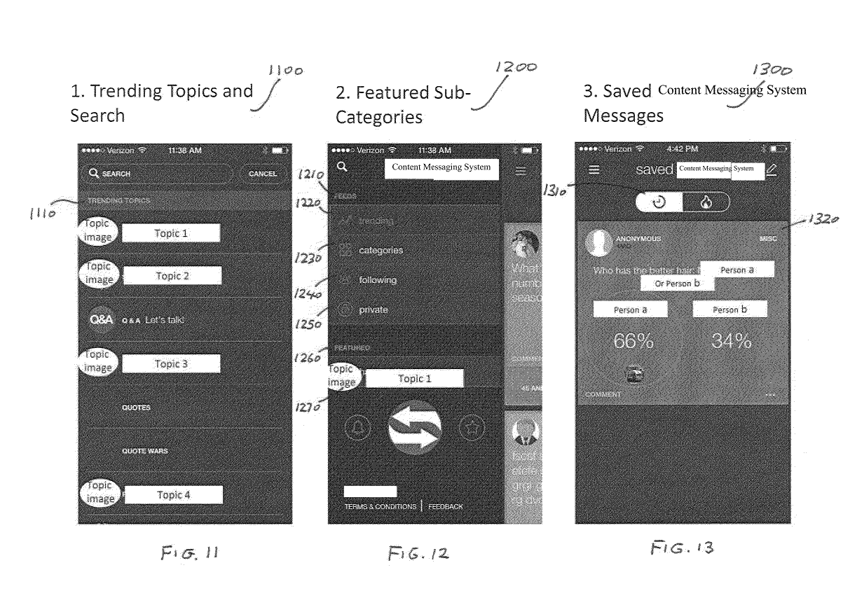

In some embodiments, the content messaging service system can also have the ability to create private sub-categories at the request of partners. For example, FIG. 15 illustrates a private messages display of the content messaging service system in accordance with some embodiments of the invention. The private messages display can include a private messaging screen 1500 comprising a private message window 1510 in some embodiments.

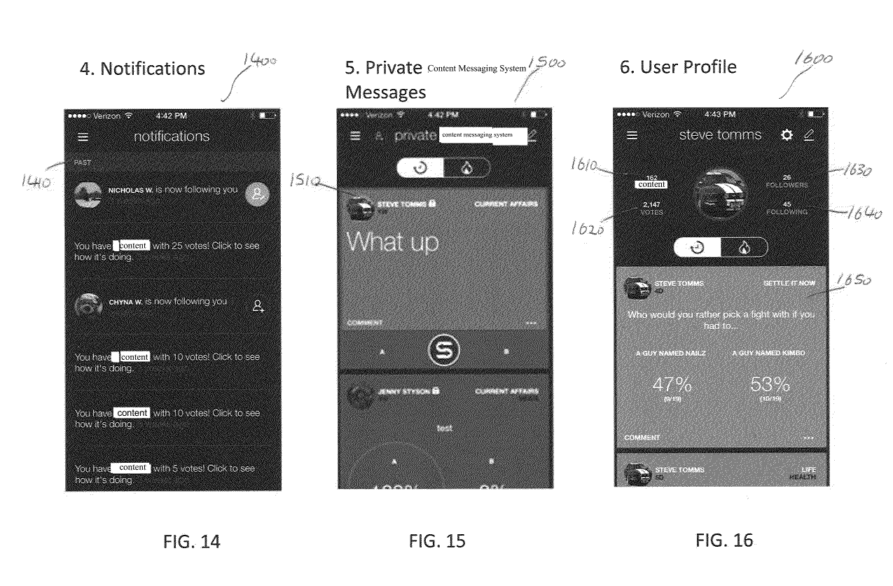

In some embodiments, the content messaging service system can enable a user to create and customize their user profile. In some embodiments, this can include creating and adding at least one of a unique user name, an image icon, background image, interests, hometown, and other personal user information. In some embodiments, the user can follow a series of steps generated by the content messaging service system to create this profile. For example, FIG. 16 illustrates a user profile display (user profile screen 1600) of the content messaging service system in accordance with some embodiments of the invention. In some embodiments, the user profile screen 1600 can include content messages total 1610, and/or votes total 1620, and/or followers total 1630, and/or following total 1640. Further, in some embodiments, the user profile screen 1600 can include a content message window 1650. In some embodiments, the content messaging service system can enable users to view what other users have voted on, who they are following, and what messages they have written. In some embodiments, this can be accomplished by allowing users to click on buttons associated with a user's profile that display a screen of “Votes” (1620), “Following” (1640), “Followers” (1630), and “Messages” (1610).

In some embodiments of the invention, the content messaging service system can include one or more administration functions. For example, in some embodiments, the content messaging service system can comprise one or more administrator portals through which one or more content messaging service system administrators can access, view, create, and/or modify various aspects and functions of the content messaging service system. Some embodiments of the invention include a content messaging service system that can facilitate the creation of a data dashboard that can display user profile data for both internal reporting and external reporting purposes. For example, in some embodiments, the content messaging service system can enable an administrator to create both standard reports and custom reports that aggregate and display data based on various criteria, including, but not limited to votes, comments, views, messages, friends, saves, location, gender, age and other demographic data points.

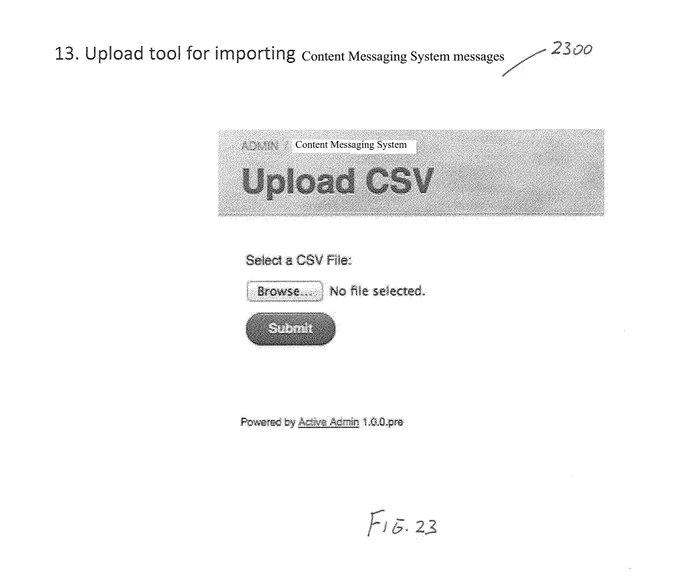

In some embodiments of the invention, the employees of content messaging service system (e.g., administrators) or a 3rd parties can use the content messaging service system to view and edit content including content messaging service system messages and comments that are written by users. In some embodiments, the administrators can also be provided with the ability to upload content via an import tool that can then be directly displayed within the content messaging service system. In some embodiments, the upload can be performed via a Microsoft® Excel® or a basic comma-separated-value (CSV) data file where the creator of the file can list at least one question, and two or more answer choices, the user, and the category. Referring to FIG. 23, illustrating an upload tool 2300 for importing messages of the content messaging service system. In some embodiments, the upload tool 2300 can be provided by the content messaging service system and used by an administrator for importing content messaging service system messages. In some embodiments, the administrator will have the ability to upload content messaging service system messages, user and channel information via an upload tool 2300. The upload tool can import a CSV or Microsoft® Excel® file and render it into the database (which in turn can then display the content messaging service system message live on the content messaging service system). In some embodiments, the posting of content can be delayed at the administrators' request. Microsoft is a registered trademark of Microsoft Corporation in the United States and/or other countries. Excel is a registered trademark of Microsoft Corporation in the United States and/or other countries.

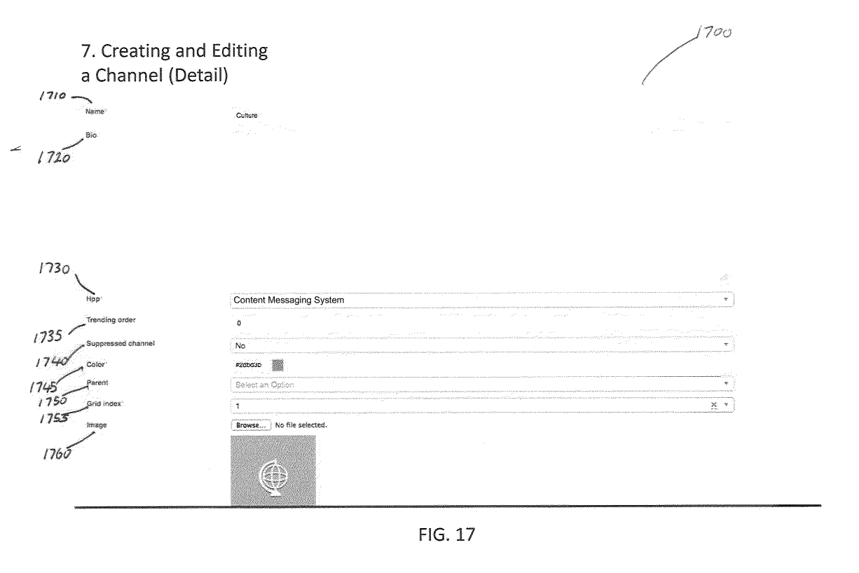

In some embodiments, the content messaging service system can enable the administrator to suspend or delete users. In some further embodiments, the content messaging service system can enable the administrator to create, modify or delete content categories and sub-categories. In some other embodiments, the content messaging service system can enable the administrator to create a list of trending categories for display in a certain order on the content messaging service system. Referring to FIG. 17, illustrating a creating and editing a channel 1700 of the content messaging service system, in some embodiments, the content messaging service system can provide a user with administrative privileges through the creating and editing a channel 1700 that can serve as one example of an administration panel. In other embodiments, the content messaging service system can enable the administrator to create a channel and give it a name field (1710), create and update a bio field (1720), select who can edit that channel from the app itself (HPP field, and shown as 1730), select it's trending order field (shown as 1735), give it a background color field (shown as 1745), turn it into a sub-channel field (1740), and associate it with another parent channel field (1750), and add it to a grid field of other channels (1755). Further, in some embodiments, the content messaging service system can enable an administrator to browse for and upload an image (image field 1760).

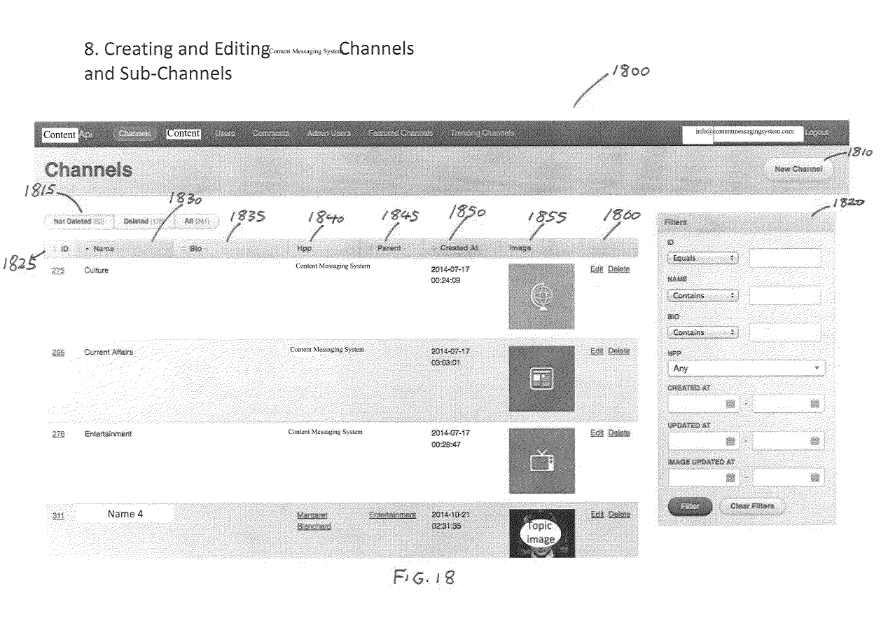

In some embodiments, the content messaging service system can enable the administrator to create and edit one or more channels and/or sub-channels. In some embodiments, the content messaging service system can enable the administrator to view all channels and sub-channels, search for channels and sub-channels and edit or delete channels or sub-channels. For example, FIG. 18 illustrates a creating and editing channels display 1800 of the content messaging service system in accordance with some embodiments of the invention. In some embodiments, the content messaging service system can enable the administrator to use the creating and editing channels and sub-channels display 1800 to view, search, create, edit, and delete one or more channels using various functions rendered on the creating and editing channels display 1800. For example, in some embodiments, the creating and editing channels display 1800 can comprise a new channel button 1810 that can be used to create a new channel. Further, in some embodiments, the channels and sub-channels display 1800 can comprise a channels table 1815 that includes an ID field 1825 including identifying information for channels. Further, in some embodiments, the channels and sub-channels display 1800 can comprise a name field 1830 that can include the name of a channel. In some further embodiments, the channels and sub-channels display 1800 can comprise a bio field 1835 and an HPP field 1840 for channels. Further, in some embodiments, the channels and sub-channels display 1800 can comprise a parent field 1845, and/or a created at field 1850, and/or an image field 1855, and/or an edit and delete field 1860. In some embodiments, biographical and other information concerning the channel can be provided in the bio field 1835, and the HPP field 1840 can include the identification of an HPP associated with the channel. In some embodiments, the parent 1845 can comprise a parent channel (e.g., the channel is a sub-channel of the listed parent channel). In some embodiments, the channel creation date can be provided in the created at field 1850. In some further embodiments, an image associated with the channel can be viewed, uploaded, or modified by an administrator in the image field 1855. In some embodiments, the edit and delete field 1860 can be used to edit or delete information within the channels table 1815. Further, in some embodiments, the filters tool 1820 can be used to filter content of the channels table 1815.

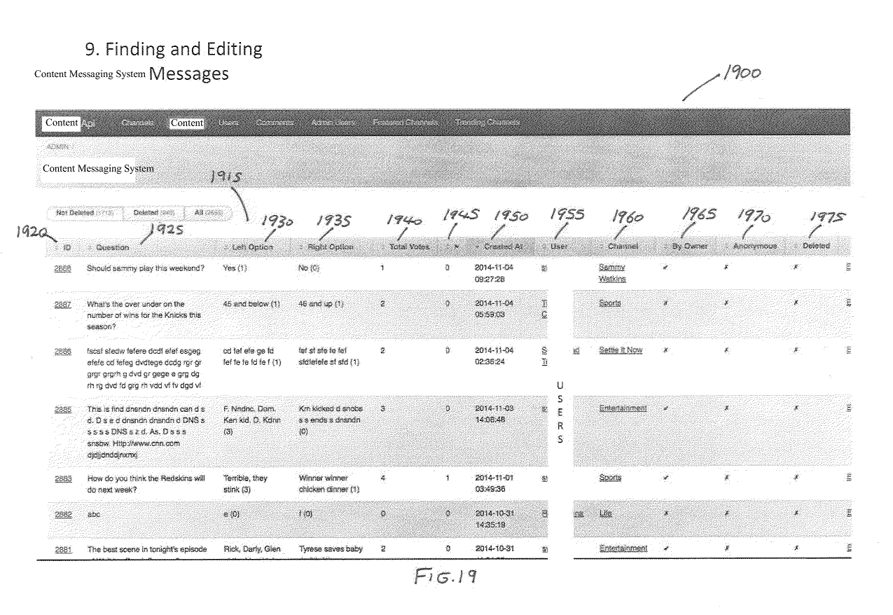

In some embodiments, the content messaging service system can enable the administrator to find, create, and edit content messaging service system messages. In some embodiments, the content messaging service system can enable the administrator to search for content messaging service system messages, edit content messaging service system messages, and delete content messaging service system messages. Referring to FIG. 19, illustrating finding and editing messages display 1900 of the content messaging service system, in some embodiments, the content messaging service system can render a finding and editing content messages display 1900 comprising a content and messages table 1915. In some embodiments, the content and messages table 1915 can comprise an ID field 1920 comprising an identifier for a content messaging service system message. Further, the content and messages table 1915 can comprise a question field 1925 including content messaging service system message questions. In some embodiments, answers to the questions can be provided in the left option field 1930 and the right option field 1935. The content and messages table 1915 can also comprise a total votes field 1940, and/or a flag field 1945, and/or a created at field 1950, and/or a user field 1955, and/or a channel field 1960, and/or a by owner field 1965, and/or an anonymous field 1970, and/or a deleted field 1975. In some embodiments, the content messaging service system can include total votes for any one of the messages in the total votes field 1940. The user field 1955 can comprise user identification associated with messages, and the channel can be provided in the channel field 1960.

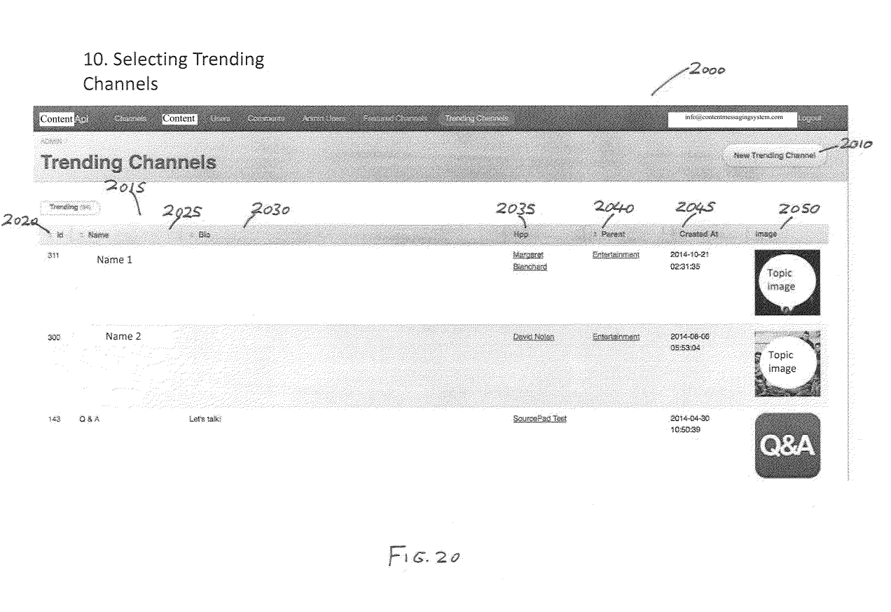

In some embodiments, the content messaging service system can enable the administrator to select already created channels or sub-channels and convert them into trending channels or sub-channels that will be displayed in the “Trending” parts of the application. For example, FIG. 20 illustrates selecting and trending channels content display 2000 messaging service system in accordance with some embodiments of the invention. In some embodiments, the selecting trending channels display 2000 can comprise a new trending channel button 2010 that can be used to create and/or assign a new trending channel. In some embodiments, the selecting trending channels display 2000 render a trending channels table 2015 providing information related to trending channels. In some embodiments, the trending channels table 2015 can comprise an ID field 2020 that can include identifying information, and a name field 2025, and/or bio field 2030, and/or HPP field 2035, and/or parent field 2040, and/or created at field 2045, and/or image field 2050.

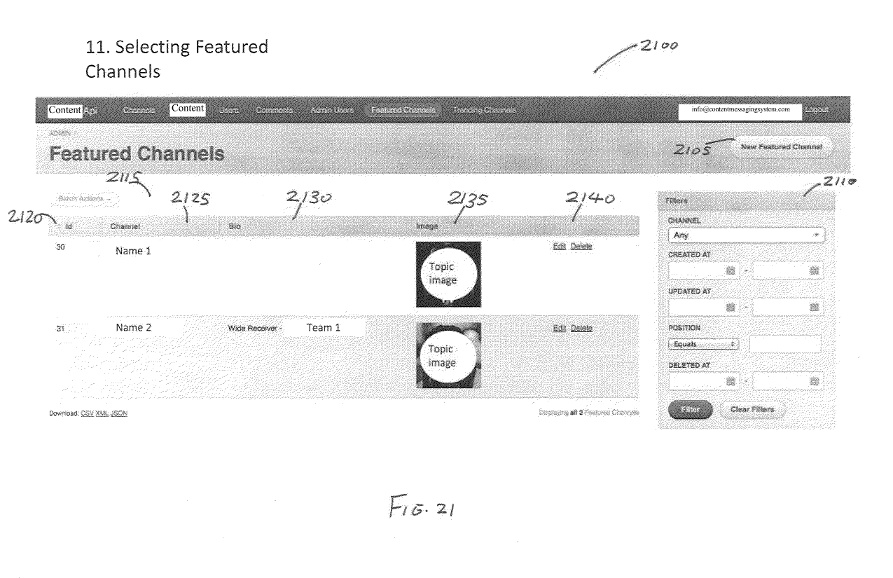

In some embodiments, the content messaging service system can enable the administrator to have the ability to select already created channels or sub-channels and convert them into featured channels or sub-channels that will be displayed in the “Featured” parts of the application. For example, FIG. 21 illustrates selecting featured channels display 2100 of the content messaging service system in accordance with some embodiments of the invention. In some embodiments, the selecting featured channels display 2100 can comprise a new featured channel button 2105 from which an administrator can create and/or assign a new featured channel. Further, in some embodiments, the featured channels display 2100 can comprise a filters tool 2110 for filtering information displayed in the featured channels table 2115. In some embodiments, the featured channels table 2115 can comprise various data fields related to featured channels. For example, the featured channels table 2115 can comprise an ID field 2120 that can include an identification of featured channels. Further, the featured channels table 2115 can comprise a channel field 2125, and/or a bio field 2130, and/or an images field 2135, and/or an edit and delete field 2140. In some embodiments, the name of a featured channel can be including in the channel field 2125, and a description and/or information related to the featured channel can be included in the bio field 2130. In some embodiments, an image associated with the featured channel can be included in the image field 2135. In some embodiments, any of the fields of the featured channels table 2115 can be edited and/or deleted using the edit and delete field 2140.

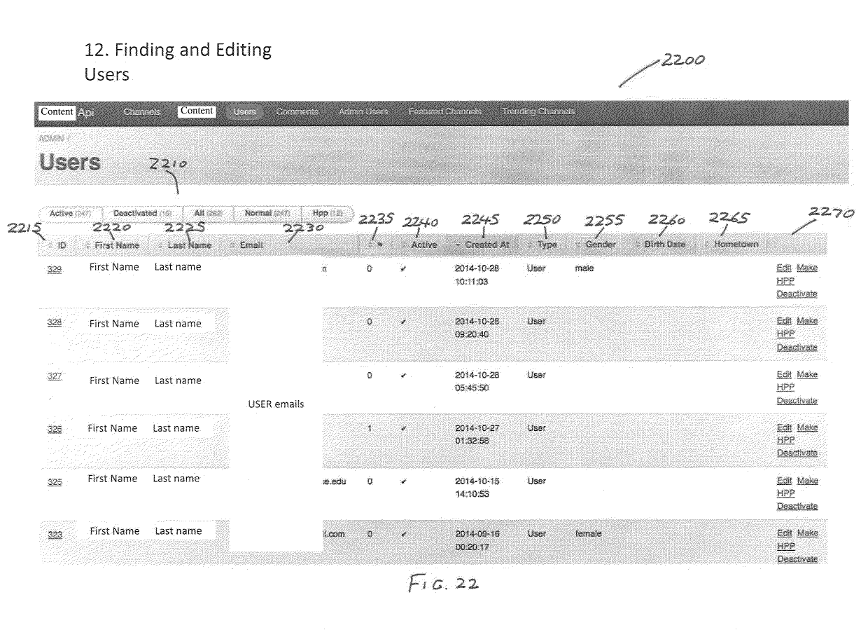

In some embodiments, the content messaging service system can enable the administrator to find and edit users of the content messaging service system. In some embodiments, the content messaging service system can enable an administrator to search for content messaging service system users, edit content messaging service system users, and delete content messaging service system users. In some embodiments, by clicking on a user, the content messaging service system can enable the administrator to view information about the user including demographical information, vote information, friends information and other relevant information. For example, FIG. 22 illustrates finding and editing users display 2200 of the content messaging service system in accordance with some embodiments of the invention. In some embodiments, the finding and editing users display 2200 can comprise a user information table 2210 with various data fields, including, but not limited to an ID field 2215, a first name field 2220, a last name field 2225, an email field 2230, a flag field 2235, and active field 2240, a created at field 2245, a type field 2250, a gender field 2255, a birth date field 2260, a hometown field 2265, and an editing field 2270. In some embodiments, name and contact information of a user can be provided in the fields 2220, 2225, 2230 for a user with an identifier in the ID field 2215. In some embodiments, various other personal information can be provided in the fields 2255, 2260, 2265 including the user's gender, birthdate, and hometown. In some embodiments, the user information table 2210 can comprise information related to the user information creation date (field 2245). Further, in some embodiments, any of the information and/or fields in the information table 2210 can be editing, assigned to an HPP, and/or deactivated using the editing field 2270.

Some embodiments of the invention include a content messaging service system that can facilitate the creation of at least one internal user profiles. For example, in some embodiments, the content messaging service system can be configured to track and organize the actions of one or more individual users. In some embodiments, these actions can include, but not be limited to what categories the user clicks and searches, views and votes on, and who they follow, and who follows them. In some embodiments, the content messaging service system can use this information to build a unique user profile that describes the user's interests. For example, if a user has written 10 messages and voted on 200, the content messaging service system can know and rank what categories of messages the user has written to, and what categories of messages the user has voted on. In some embodiments, the content messaging service system can enable an administrator to know who the user is following, and their demographics and relationship to the user socially and geographically. In some embodiments, this user profile can be converted into a broad web based description of the user that brands, celebrities, and other purchasers of content messaging service system data can understand. In some embodiments, this process can allow for targeting of specific types of users. For example, a brand may want to reach all female users who live on the west coast of the United States, and have answered at least 10 fashion questions with a message about a new body wash. In some embodiments, the content messaging service system can provide a separate analytics package that can be available for the 3rd party content provider to track users who interact with their message, vote, comment, share, and other actions, etc.

In some embodiments of the invention, the content messaging service system can enable a user to display one or more vote totals. In some embodiments, the content messaging service system can enable a user to see both their vote totals as well as other users' vote totals.

In some embodiments of the invention, the content messaging service system can enable badging and achievements functions. For example, in some embodiments, the content messaging service system can enable users to earn badges for completing certain tasks including but not limited to voting, inviting friends, sharing, commenting, writing and logging on.

In some embodiments of the invention, the content messaging service system can enable a determination of at least a part of a user's personality. For example, in some embodiments, a user can answer a series of questions that can help the content messaging service system determine the user's personality type. In some embodiments, the content messaging service system can use this personality type to serve specific messages (e.g., more relevant and/or targeting messages), connect users to relevant brands or other content/marketing partners, and provide users with a more customized experience. In other embodiments, the content messaging service system can systematically and algorithmically determine a user's personality type based at least in part on what types of messages are written by the user, what types of comments are written by a user, and/or what type of messages are voted on by the user. In some embodiments, the content messaging service system can also examine who the user follows, and who their friends are on the content messaging service system.

In some embodiments of the invention, the content messaging service system can faciliate the use of color and/or text, and/or graphical symbols to enable a viewing user to associate various representations and information displayed by the content messaging service system. For example, in some embodiments, the color of the category header, the “S” slider vote icon and the comment total can match the color of the overall category. In some embodiments, this matching process can be enabled by a backend administration. In some further embodiments, color and/or text, and/or graphical symbols can be changed in real-time. Further, some other embodiments of the invention can enable users to customize their own colors and headers. In this instance, the content messaging service system can enable the user to have access to a “customize” section of the application from which the user can choose from a list of colors.

In some embodiments of the invention, the content messaging service system can display a home page that displays either curated or user generated content for all users to see. For example, in some embodiments, the home page can comprise content displayed on home screens 100, 110, 150 described earlier and shown in FIGS. 1A-1C. In some embodiments, this content can include the most popular messages of the day/week, etc., the top voters, the top followed, the top following, or other such examples. In some embodiments, the home page can also display a user's profile information and rank within the network. Further, in some embodiments, the content messaging service system server's and administrative panel can allow the content messaging service system to select which messages are curated on the home page, and/or which users are highlighted on the home page, and/or which categories and sub-categories are highlighted on the home page. In some embodiments, the content messaging service system can enable these elements to be added, modified and deleted in real-time.

Some embodiments of the invention can enable 3rd party customized content messaging service system messages. For example, in some embodiments, the content messaging service system can allow for 3rd party content providers to create their own customized content messaging service system messages on their own websites, mobile sites, and other content portals. In some embodiments, this process can be completed through an iFrame, HTML widget or other similar method. Further, in some embodiments, this process can enable the creation of customized frames that can live on an external web page. In some embodiments, one or more customized frames can be connected to a content messaging service system database, and can allow the 3rd party to display content messaging service system content within their own web properties.

In some embodiments, the content messaging service system can be configured to provide a customized tool that can allow the 3rd party content to create content messaging service system messages on their own internal HTML web pages. In some embodiments, this tool can allow editors and other content creators to write content messaging service system messages and the answer choices. Further, in some embodiments, editors and other content creators can then submit these messages, which can then be carried to a content messaging service system server. In some embodiments, the content messaging service system server can format and display the message back on the customized iFrame that was created for the 3rd part content provider. Additionally, in some embodiments, the content messaging service system server can simultaneously display the message in the standard content messaging service system for viewing by users of the content messaging service system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A system for facilitating user engagement with a high profile person or brand, comprising:
at least one processor configured to couple to at least one server and at least one non-transitory computer-readable storage medium for tangibly storing information related to at least one user account, the non-transitory computer-readable storage medium including program logic defining a content message service that facilitates engagement of a user with at least one high profile person, which when executed by the processor, performs steps comprising:
providing an option to a user to create a user account and provide user profile information to the content message service;
calculating and rendering at least one user interface on a computer device of a viewing user that is coupled to the content message service;
providing an option to the user to select and view at least one content category;
providing an option to a user to create and post at least one content message;
calculating a content message ranking and a decay for each posted content message;
displaying the at least one content message within the least one user interface based at least in part on the decay;
providing an option to a user to create at least one votable answer associated with the at least one content message;
providing an option to the viewing user to place a vote by selecting the at least one votable answer;
compiling a total number of content messages composed by the user;
compiling a total number of responses to the content messages composed by the user;
compiling a high profile person viewing or response total from the at least one high profile person's viewing or response behavior to the at least one content message;
calculating and assigning a status category, a score, and a status value to the user based at least in part on at least one of the total number of content messages composed by the user, total number of responses to the content messages composed by the user, and a high profile person viewing or response total; and
displaying the status category of a user associated with the at least one high profile person when requested by the user.

2. The system of claim 1, wherein the decay is a function of a level of decay calculated by the content message service using the processor.

3. The system of claim 2, wherein the level of decay is defined by the content messaging service based on the number of newly created content messages.

4. The system of claim 2, wherein the level of decay is defined by the content messaging service based on a content message's age relative to its finite life.

5. The system of claim 2, wherein the level of decay is defined by the content messaging service based on the content message's rank.

6. The system of claim 1, wherein the user comprises a high profile person.

7. The system of claim 1, wherein the high profile person comprises a brand.

8. The system of claim 1, wherein the high profile person comprises an organization.

9. The system of claim 1, wherein the high profile person comprises at least one of an athlete, an artist, an entertainer, an actor, a musician, a dancer, a comedian, and a celebrity.

10. The system of claim 1, wherein the option to place a vote comprises the content message service recognizing and accepting a user selection of a voting button or icon.

11. The system of claim 10, wherein the voting button or icon is configured to be activated by a user swipe.

12. The system of claim 10, wherein the voting button or icon is configured to be activated by at least one user gesture.

13. The system of claim 1, wherein assignment of a status category to the user is dependent on the purchase of content message influence via an in-application purchase by the user.

14. The system of claim 1, further comprising the processor executing the program logic to configure the user interface display to enable a user to complete or cancel a purchase of content message influence related to the at least one high profile person.

15. The system of claim 1, wherein the user profile information is provided through at least one third-party social media system.

16. The system of claim 1, further comprising the processor executing the program logic to configure the user interface display with a find a friend or follower function.

17. The system of claim 1, further comprising the processor executing the program logic to enable a user to invite one or more friends to the content messaging service.

18. The system of claim 1, further comprising the processor executing the program logic to display trending information and at least one trending content message.

19. The system of claim 1, wherein the processor executes the program logic to display at least one advertisement on the at least one user interface.

20. The system of claim 19, wherein the at least one advertisement comprises at least one of feed brand content messages ads with call to action, special offers, and alerts for discounts from advertising or brand partners.

21. The system of claim 1, wherein the prominence of display of the at least one content message is based at least in part on the content message ranking.

22. The system of claim 1, wherein the content message ranking is a function of the status category of the user.

23. The system of claim 1, wherein the content message ranking is defined by an equation comprising number of responses (“R”)×author's status (“S”)×decay (“D”).

24. The system of claim 2, wherein the level of decay depends on a decay bonus earned; and wherein the decay bonus is based on the status category of the user.

25. The system of claim 1, wherein the status category of a user is further defined by:
(# of content messages created×X %)+(# of user responses×Y %)+(#HPP responses×Z)
where the variables X % and Y % are weighting factors that ranges between about 0 and about 100%, and Z is a weighting factor that ranges between about 0 and about 100.

26. The system of claim 1, wherein the content message service is configured to couple to one or more 3^{rd} party content providers websites, mobile sites, and other content portals; and
wherein the one or more 3^{rd} party content providers can display at least one content message using HTML code.

27. The system of claim 26, wherein the HTML code comprises an iframe.
